(19) United States
(12) Patent Application Publication
(10) Pub. No.: US 2016/0123247 A1
(43) Pub. Date: May 5, 2016

(54) CONTROL APPARATUS FOR INTERNAL COMBUSTION ENGINE

(71) Applicant: TOYOTA JIDOSHA KABUSHIKI KAISHA, Toyota-shi, Aichi-ken (JP)

(72) Inventors: Hiroaki MIZOGUCHI, Mishima-shi, Shizuoka-ken (JP); Yusuke SUZUKI, Hadano-shi, Kanagawa-ken (JP); Yoshihiro SAKAYANAGI, Mishima-shi, Shizuoka-ken (JP); Shigeyuki URANO, Gotenba-shi, Shizuoka-ken (JP)

(73) Assignee: TOYOTA JIDOSHA KABUSHIKI KAISHA, Toyota-shi, Aichi-ken (JP)

(21) Appl. No.: 14/892,773

(22) PCT Filed: May 21, 2014
(86) PCT No.: PCT/JP2014/064040

§ 371 Date: Nov. 20, 2015

(30) Foreign Application Priority Data
May 31, 2013 (JP) 2013-115282

(51) Int. Cl. F02D 35/02; F02D 41/00; F02D 41/30; F02P 9/00

(52) U.S. Cl. CPC F02D 35/023; F02P 9/002; F02D 41/0002; F02D 41/3005; F02D 41/0077; F02D 35/025

(57) ABSTRACT

A control apparatus for an internal combustion engine includes an in-cylinder pressure sensor for detecting an in-cylinder pressure. In-cylinder heat release amount data is calculated based on in-cylinder pressure data synchronized with the crank angle that is sampled using the in-cylinder pressure sensor. If the number of items of the heat release amount data that are located in a combustion period identified using the heat release amount data is two or more, the control apparatus determines that the in-cylinder pressure data that is sampled in synchronization with the crank angle is reliable and the engine can be controlled accordingly.

### TECHNICAL FIELD

This invention relates to a control apparatus for an internal combustion engine, and more particularly to a control apparatus for an internal combustion engine that is favorable as an apparatus that executes various kinds of engine control, various kinds of determination processing and various kinds of estimation processing utilizing detection values of an in-cylinder pressure sensor.

### BACKGROUND ART

An apparatus that detects the operating state of an internal combustion engine is known, as disclosed, for example, in Patent Literature 1. The aforementioned conventional apparatus includes a sensor (for example, an in-cylinder pressure sensor) that detects an operating state of the internal combustion engine, and in accordance with the operating state (engine rotational speed), performs sampling of detection values of the sensor at synchronized timings or in synchronization with the crank angle.

Including the above described literature, the applicant is aware of the following literature as related art of the present invention.

### CITATION LIST

### Patent Literature

Patent Literature 1: Japanese Laid-open Patent Application Publication No. 2-099743

Patent Literature 2: Japanese Laid-open Patent Application Publication No. 11-190250

Patent Literature 3: Japanese Laid-open Patent Application Publication No. 2010-127102

### SUMMARY OF INVENTION

### Technical Problem

An in-cylinder pressure waveform at the time of combustion can be captured by means of an in-cylinder pressure sensor. Further, combustion analysis (calculation of a heat release amount, a mass fraction burned, a 50% burning point and the like) can be performed using in-cylinder pressure data that is synchronized with the crank angle. However, if the engine rotational speed is too low, the interval for sampling the in-cylinder pressure data in synchronization with the crank angle lengthens, and hence it becomes difficult to reliably capture an in-cylinder pressure waveform at the time of combustion. Further, sampling of in-cylinder pressure data that is performed to capture an in-cylinder pressure waveform at the time of combustion is influenced not only by the engine rotational speed, but also by the combustion speed. The combustion speed changes according to the operating state of the internal combustion engine and the like, even if the engine rotational speed stays the same. Therefore, even if the engine rotational speed stays the same, a case in which highly accurate sampling of in-cylinder pressure data can be performed and a case in which such sampling cannot be performed can arise depending on the combustion speed. Accordingly, the following problem arises in the case of employing a method that, in accordance with the engine rotational speed, switches between using and not using in-cylinder pressure data that is synchronized with the crank angle, such as the method described in the aforementioned Patent Literature 1. That is, in a case where a threshold value of an engine rotational speed at which to switch to crank angle synchronization is set to a high value with the intention of ensuring highly reliable sampling of in-cylinder pressure data, even when it can be said that, depending on the combustion speed, reliability is actually ensured on a low engine rotational speed side, it means that sampling of in-cylinder pressure data that is synchronized with the crank angle cannot be performed. In this respect, the method described in the aforementioned Patent Literature 1 still contains room for improvement with regard to determining whether or not the reliability of sampled in-cylinder pressure data is sufficient.

The present invention has been conceived to solve the above described problem, and an object of the present invention is to provide a control apparatus for an internal combustion engine that can simply and accurately determine the reliability of in-cylinder pressure data that is sampled in synchronization with the crank angle.

### Solution to Problem

A first aspect of the present invention is a control apparatus for an internal combustion engine, comprising:

an in-cylinder pressure sensor for detecting an in-cylinder pressure;

heat release amount data calculation means for calculating heat release amount data for inside a cylinder based on in-cylinder pressure data synchronized with a crank angle that is sampled using the in-cylinder pressure sensor; and

data reliability determination means for determining that the in-cylinder pressure data synchronized with a crank angle that is sampled is reliable in a case where the number of items of the heat release amount data located in a combustion period that is identified using the heat release amount data is two or more.

A second aspect of the present invention is the control apparatus for an internal combustion engine according to the first aspect of the present invention, further comprising:

an actuator for controlling the internal combustion engine; and

control switching means for switching control of the actuator based on combustion analysis that utilizes the in-cylinder pressure data between a case where the number of items of the heat release amount data located in a combustion period that is identified using the heat release amount data is two or more and a case where the number of items of the heat release amount data located in the combustion period is less than two.

A third aspect of the present invention is the control apparatus for an internal combustion engine according to the second aspect of the present invention,

wherein the control switching means allows execution of the control of the actuator based on combustion analysis that utilizes the in-cylinder pressure data in the case where the number of items of the heat release amount data located in the combustion period is two or more, and prohibits execution of the control of the actuator in the case where the number of items of the heat release amount data located in the combustion period is less than two.

A fourth aspect of the present invention is the control apparatus for an internal combustion engine according to the third aspect of the present invention,

wherein the control of the actuator is feedback control that relates to a predetermined control target parameter using the actuator and is based on combustion analysis that utilizes the in-cylinder pressure data, and

wherein the control switching means allows execution of the feedback control in the case where the number of items of the heat release amount data located in the combustion period is two or more, and prohibits execution of the feedback control in the case where the number of items of the heat release amount data located in the combustion period is less than two.

A fifth aspect of the present invention is the control apparatus for an internal combustion engine according to the third aspect of the present invention,

wherein the control of the actuator is feedback control that relates to a predetermined control target parameter using the actuator and is based on combustion analysis that utilizes the in-cylinder pressure data, and

wherein the control switching means reduces a feedback gain in the feedback control in the case where the number of items of the heat release amount data located in the combustion period is less than two in comparison to the case where the number of items of the heat release amount data located in the combustion period is two or more.

A sixth aspect of the present invention is the control apparatus for an internal combustion engine according to any one of the first to fifth aspects of the present invention, further comprising determination processing switching means for allowing execution of predetermined determination processing based on combustion analysis that utilizes the in-cylinder pressure data in the case where the number of items of the heat release amount data located in the combustion period is two or more, the determination processing switching means being for prohibiting execution of the determination processing or allowing execution of the determination processing based on another method that does not utilize the in-cylinder pressure data or utilizes a part of the in-cylinder pressure data in the case where the number of items of the heat release amount data located in the combustion period is less than two.

A seventh aspect of the present invention is the control apparatus for an internal combustion engine according to any one of the first to sixth aspects of the present invention, further comprising estimation processing switching means for allowing execution of estimation processing to estimate a predetermined parameter based on combustion analysis that utilizes the in-cylinder pressure data in the case where the number of items of the heat release amount data located in the combustion period is two or more, the estimation processing switching means being for prohibiting execution of the estimation processing or permitting execution of the estimation processing utilizing a preset value in the case where the number of items of the heat release amount data located in the combustion period is less than two.

An eighth aspect of the present invention is the control apparatus for an internal combustion engine according to any one of the first to seventh aspects of the present invention,

wherein the data reliability determination means determines that the heat release amount data that is sampled after a combustion start timing that is a starting point of the combustion period and at or before a second crank angle at which an internal energy of in-cylinder gas exhibits a maximum value is the heat release amount data located in the combustion period.

A ninth aspect of the present invention is the control apparatus for an internal combustion engine according to the eighth aspect of the present invention,

wherein the data reliability determination means determines that the in-cylinder pressure data synchronized with a crank angle that is sampled is reliable in a case where the number of items of the heat release amount data located within a period is two or more, the period starting at or after a first crank angle that is a crank angle of an item of the heat release amount data with respect to which a heat release amount first rises relative to a minimum heat release amount and ending before the second crank angle.

A tenth aspect of the present invention is the control apparatus for an internal combustion engine according to the eighth or ninth aspect of the present invention,

wherein the data reliability determination means determines that, in a case where a plotted point of an internal energy maximum value in internal energy data that is calculated based on the in-cylinder pressure data and a plotted point of an item of the internal energy data that is at or after a first crank angle and is before the internal energy maximum value are collinear, the internal energy maximum value is an item of data before a true second crank angle, the first crank angle being a crank angle of an item of the heat release amount data with respect to which a heat release amount first rises relative to a minimum heat release amount.

An eleventh aspect of the present invention is the control apparatus for an internal combustion engine according to any one of the eighth to tenth aspects of the present invention,

wherein the data reliability determination means determines that, in a case where a plotted point of an internal energy maximum value in internal energy data that is calculated based on the in-cylinder pressure data and a plotted point of an item of the internal energy data that is at or after a first crank angle and is before the internal energy maximum value are not collinear, an item of data that is one item before the internal energy maximum value is an item of data before a true second crank angle, the first crank angle being a crank angle of an item of the heat release amount data with respect to which a heat release amount rises relative to a minimum heat release amount.

A twelfth aspect of the present invention is the control apparatus for an internal combustion engine according to the eighth or ninth aspect of the present invention,

wherein the data reliability determination means determines that an item of data that is before an internal energy maximum value in internal energy data that is calculated based on the in-cylinder pressure data is an item of data that is before a true second crank angle.

A thirteenth aspect of the present invention is the control apparatus for an internal combustion engine according to the tenth aspect of the present invention, further comprising internal energy maximum data estimation means for, in a case where the plotted point of the internal energy maximum value and the plotted point of an item of the internal energy data that is at or after the first crank angle and is before the internal energy maximum value are collinear, estimating that data with respect to an intersection point between a straight line that passes through the plotted point of an item of the internal energy maximum value and any two points among plotted points of items of the internal energy data that is at or after the first crank angle and is before the internal energy maximum value and a straight line that passes through plotted points of two items of data that are immediately after the internal energy maximum value is a true internal energy maximum value, and estimating that a crank angle at the intersection point is a true second crank angle.

A fourteenth aspect of the present invention is the control apparatus for an internal combustion engine according to the eleventh aspect of the present invention, further comprising internal energy maximum data estimation means for, in a case where the plotted point of the internal energy maximum value and the plotted point of an item of the internal energy data that is at or after the first crank angle and is before the internal energy maximum value are not collinear, estimating that data with respect to an intersection point between a straight line that passes through any two points among plotted points of items of the internal energy data that is at or after the first crank angle and is before the internal energy maximum value and a straight line that passes through the plotted point of the internal energy maximum value and a plotted point of an item of data that is one item after the internal energy maximum value is a true internal energy maximum value, and estimating that a crank angle at the intersection point is a true second crank angle.

A fifteenth aspect of the present invention is the control apparatus for an internal combustion engine, according to any one of the first to thirteenth aspects of the present invention, further comprising internal energy maximum data estimation means for estimating that data with respect to an intersection point between a straight line that passes through plotted points of two items of data that are immediately before an internal energy maximum value in internal energy data that is calculated based on the in-cylinder pressure data and a straight line that passes through plotted points of two items of data that are immediately after the internal energy maximum value is a true internal energy maximum value, and estimating that a crank angle at the intersection point is a true second crank angle.

A sixteenth aspect of the present invention is the control apparatus for an internal combustion engine according to any one of the thirteenth to fifteenth aspects of the present invention, further comprising additional in-cylinder pressure calculation means for calculating an in-cylinder pressure at the true second crank angle using a true internal energy maximum value and a true second crank angle that are estimated by the internal energy maximum data estimation means.

A seventh aspect of the present invention is the control apparatus for an internal combustion engine according to the tenth aspect of the present invention, further comprising maximum heat release amount data setting means for, in a case where the plotted point of the internal energy maximum value and the plotted point of the item of the internal energy data that is at or after the first crank angle and is before the internal energy maximum value are collinear, setting, as data of a maximum heat release amount, the heat release amount data corresponding to an item of data that is one item after the internal energy maximum value or corresponding to an item of data that is a further one item after the item of data.

An eighteenth aspect of the present invention is the control apparatus for an internal combustion engine according to the eleventh aspect of the present invention, further comprising maximum heat release amount data setting means for, in a case where the plotted point of the internal energy maximum value and the plotted point of item of the internal energy data data that is at or after the first crank angle and is before the internal energy maximum value are not collinear, setting, as data of a maximum heat release amount, the heat release amount data corresponding to the internal energy maximum value or corresponding to an item of data after the internal energy maximum value.

### Advantageous Effects of Invention

An in-cylinder heat release amount waveform has a so-called “Z characteristic” (characteristic that a value changes stepwise in a manner in which a heat release amount Q changes abruptly during a combustion period). When it is attempted to reliably reproduce a waveform of heat release amounts having such a characteristic with heat release amount data distributed based on in-cylinder pressure data, a waveform of the heat release amounts cannot be reliably reproduced if the number of items of heat release amount data during a combustion period is less than two, and it is necessary for the number of items of heat release amount data during the combustion period to be two or more. Utilizing this fact, it can be said that when the number of items of the heat release amount data located in a combustion period is two or more, it is possible to determine that the in-cylinder pressure data sampled in synchronization with the crank angle is reliable. Therefore, according to the first aspect of the present invention, the reliability of in-cylinder pressure data that is sampled in synchronization with the crank angle can be simply and accurately determined.

According to the second to fifth aspects of the present invention, engine control (control of actuators) can be performed that effectively utilizes a combustion analysis result with respect to in-cylinder pressure data that can be determined as reliable. Further, performance of engine control based on a combustion analysis that utilizes unreliable in-cylinder pressure data can be prevented.

According to the sixth aspect of the present invention, determination processing can be performed that effectively utilizes a combustion analysis result with respect to in-cylinder pressure data that can be determined as reliable. Further, performance of determination processing based on a combustion analysis that utilizes unreliable in-cylinder pressure data can be prevented.

According to the seventh aspect of the present invention, estimation processing can be performed that effectively utilizes a combustion analysis result with respect to in-cylinder pressure data that can be determined as reliable. Further, performance of estimation processing based on a combustion analysis that utilizes unreliable in-cylinder pressure data can be prevented.

According to the eighth aspect of the present invention, by utilizing the fact that, irrespective of whether or not variations arise in a waveform of heat release amounts due to thermal strain or the like, a maximum value of the internal energy of in-cylinder gas will always be before the combustion end timing, it can be determined whether or not heat release amount data is located in a combustion period.

According to the ninth aspect of the present invention, it can be reliably determined whether or not the number of items of the heat release amount data located in a combustion period is two or more by utilizing a first crank angle that is always after the combustion start timing, and a second crank angle that is always before the combustion end timing. Consequently, irrespective of whether or not variations arise in a waveform of a heat release amount Q due to the influence of thermal strain or the like, the reliability of in-cylinder pressure data sampled in synchronization with the crank angle can be accurately determined.

According to the tenth to twelfth aspects of the present invention, it is possible to determine whether or not specific sampling data is definitely data sampled during a true combustion period.

According to the thirteenth to fifteenth aspects of the present invention, it is possible to accurately estimate a true internal energy maximum value and a true second crank angle by utilizing a relative positional relationship between data items with respect to the internal energy.

According to the sixteenth aspect of the present invention, by utilizing a true internal energy maximum value and a true second crank angle that are estimated as described above, the number of data items with respect to the in-cylinder pressure can be increased by one item when performing combustion analysis utilizing sampling data for the in-cylinder pressure.

According to the seventeenth and eighteenth aspects of the present invention, by utilizing a relative positional relationship between data items for the internal energy, it is possible to accurately identify data for a maximum heat release amount irrespective of whether or not variations arise in a waveform of heat release amounts due to the influence of thermal strain or the like.

### BRIEF DESCRIPTION OF DRAWINGS

FIG. 1 is a view for describing the system configuration of an internal combustion engine according to a first embodiment of the present invention;

FIG. 2 is a time chart that represents operations at ignition start-up;

FIG. 3 is a view for describing variations in a guaranteed rotation speed with respect to the accuracy of sampling that is synchronized with a crank angle that are caused by variations in a combustion speed;

FIG. 4 is a view that illustrates differences in heat release amount waveforms in accordance with changes in the combustion speed under the same engine rotational speed;

FIG. 5 is a view that illustrates basic waveforms with respect to an in-cylinder pressure P, a heat release amount Q, and a mass fraction burned MFB;

FIG. 6 is a view that illustrates combustion analysis examples in a case where less than two items of in-cylinder pressure data have been sampled in synchronization with the crank angle during a combustion period (θmin to θmax);

FIG. 7 is a view that illustrates combustion analysis examples in a case where two or more items of in-cylinder pressure data have been sampled in synchronization with the crank angle during the combustion period (θmin to θmax);

FIG. 8 is a flowchart of a routine that is executed in the first embodiment of the present invention;

FIG. 9 is a view for describing a problem relating to the determination method of the first embodiment of the present invention;

FIG. 10 is a view for describing a problem relating to the determination method of the first embodiment of the present invention;

FIG. 11 is a view illustrating changes in an internal energy PV and the heat release amount Q with respect to the crank angle, respectively;

FIG. 12 is a flowchart of a routine that is executed in a second embodiment of the present invention;

FIG. 13 is a view for describing the method for determining if heat release amount data is data before a true second crank angle θ2 (that is, data acquired during combustion);

FIG. 14 is a view for describing the method for determining if heat release amount data is data before the true second crank angle θ2 (that is, data acquired during combustion);

FIG. 15 is a view for describing a method that estimates a true PVmax and the true second crank angle θ2 using data for the internal energy PV that was calculated utilizing sampling data of the in-cylinder pressure;

FIG. 16 is a view for describing a method that estimates the true PVmax and the true second crank angle θ2 using data for the internal energy PV that was calculated utilizing sampling data of the in-cylinder pressure;

FIG. 17 is a view for describing a method of identifying data of a maximum heat release amount Qmax;

FIG. 18 is a view for describing a method of identifying data of the maximum heat release amount Qmax;

FIG. 19 is a flowchart of a routine that is executed in a third embodiment of the present invention;

FIG. 20 is a view for describing another method of determining heat release amount data during a combustion period;

FIG. 21 is a view for describing another method for estimating the true PVmax and the true second crank angle θ2 using data for the internal energy PV calculated utilizing sampling data of the in-cylinder pressure; and

FIG. 22 is a flowchart of a routine that is executed in a fourth embodiment of the present invention.

### DESCRIPTION OF EMBODIMENTS

### First Embodiment

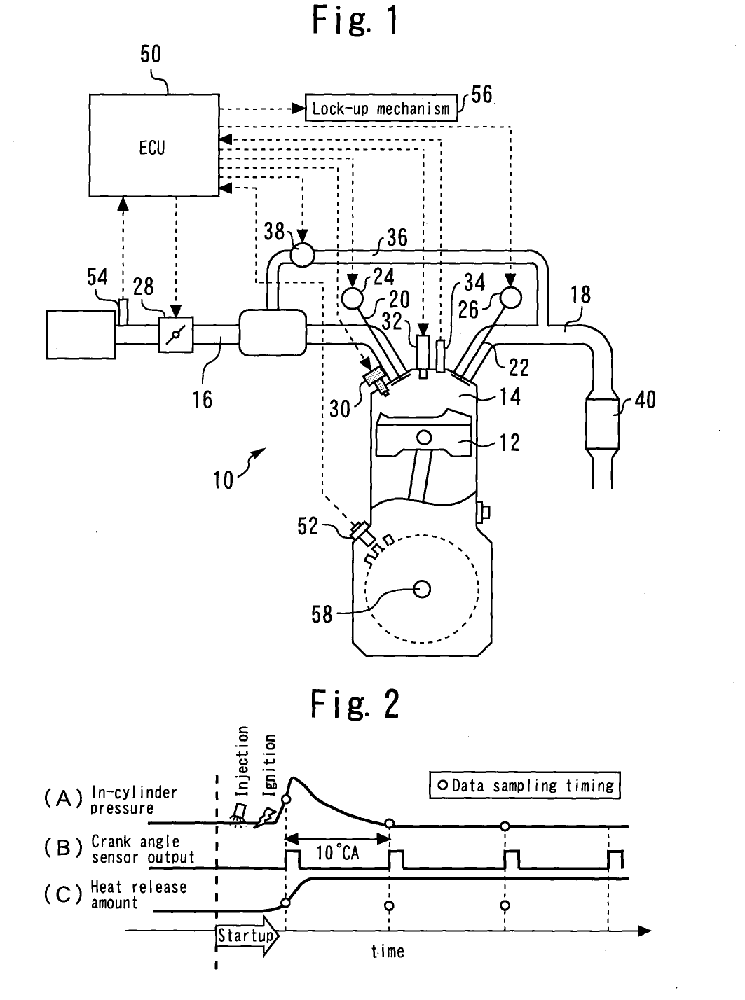

First, a first embodiment of the present invention will be described with reference to FIG. 1 to FIG. 8.

### System Configuration of Internal Combustion Engine

FIG. 1 is a view for describing the system configuration of an internal combustion engine 10 according to the first embodiment of the present invention.

The system shown in FIG. 1 includes an internal combustion engine (as one example, a spark-ignition internal combustion engine) 10. A piston 12 is provided inside each cylinder of the internal combustion engine 10. A combustion chamber 14 is formed at the top side of the piston 12 inside the respective cylinders. An intake passage 16 and an exhaust passage 18 communicate with the combustion chamber 14.

An intake valve 20 that opens and closes an intake port of the intake passage 16 is provided at the intake port. An exhaust valve 22 that opens and closes an exhaust port of the exhaust passage 18 is provided at the exhaust port. The intake valve 20 and the exhaust valve 22 are driven to open and close by an intake variable valve mechanism 24 and an exhaust variable valve mechanism 26, respectively. In this case, the variable valve mechanisms 24 and 26 respectively include a variable valve timing (VVT) mechanism for controlling opening and closing timings of the intake valve and the exhaust valve. An electronically controlled throttle valve 28 is also provided in the intake passage 16.

Each cylinder of the internal combustion engine 10 is provided with a fuel injection valve 30 for injecting fuel directly into the combustion chamber 14 (into the cylinder), and a spark plug 32 for igniting an air-fuel mixture. An in-cylinder pressure sensor 34 for detecting an in-cylinder pressure P is also mounted in each cylinder.

The internal combustion engine 10 includes an EGR passage 36 that is connected between the intake passage 16 and the exhaust passage 18. An EGR valve 38 for adjusting the amount of EGR gas (external EGR gas) that is recirculated to the intake passage 16 through the EGR passage 36 is disposed in the EGR passage 36. A catalyst 40 for purifying exhaust gas is also disposed in the exhaust passage 18.

The system of the present embodiment further includes an electronic control unit (ECU) 50. In addition to the aforementioned in-cylinder pressure sensor 34, various sensors for detecting the operating state of the internal combustion engine 10 such as a crank angle sensor 52 for detecting a crank angle and an engine rotational speed (crank angle speed) and an air flow meter 54 for measuring an intake air amount are connected to an input section of the ECU 50. Various actuators such as the variable valve mechanisms 24 and 26, the throttle valve 28, the fuel injection valve 30, the spark plug 32 and the EGR valve 38 that are described above are connected to an output section of the ECU 50. The ECU 50 performs various kinds of engine control such as fuel injection control and ignition control by driving the various actuators described above based on the output of the respective sensors and predetermined programs. The ECU 50 also has a function of synchronizing the output signal of the in-cylinder pressure sensor 34 with the crank angle that is detected by the crank angle sensor 52, and subjects the synchronized signal to AD conversion and acquires the resulting signal. It is thereby possible to detect the in-cylinder pressure P at an arbitrary timing in a range allowed by the AD conversion resolution. In addition, the ECU 50 has a function of calculating a value of an in-cylinder volume V that depends on the crank angle position, according to the relevant crank angle. An automatic transmission (AT) having an electronically controlled lock-up mechanism 56 that is controlled by the ECU 50 is also incorporated into the internal combustion engine 10.

As described above, the internal combustion engine 10 includes an in-cylinder pressure sensor 34. In the internal combustion engine 10 that includes this kind of in-cylinder pressure sensor 34, by acquiring, using the in-cylinder pressure sensor 34, in-cylinder pressure data at the time of combustion that is synchronized with the crank angle, it is possible to calculate various combustion state amounts such as a heat release amount Q that are useful when used in various kinds of engine control (fuel injection control and ignition control and the like) with respect to combustion performed in each cycle. The obtained combustion state amounts can then be reflected in the engine control of the next cycle.

### Problem Regarding Sampling of In-Cylinder Pressure Data Synchronized with Crank Angle

An in-cylinder pressure waveform at the time of combustion can be captured by means of the in-cylinder pressure sensor 34. Further, by using in-cylinder pressure data that is synchronized with the crank angle, it is possible to perform combustion analysis (calculation of combustion state amounts such as a heat release amount, a mass fraction burned, a 50% burning point (combustion center of gravity), and a torque). However, if the engine rotational speed is too low, the interval for sampling the in-cylinder pressure data in synchronization with the crank angle lengthens, and hence it becomes difficult to reliably capture an in-cylinder pressure waveform at the time of combustion. Specifically, for example, the time of ignition start-up that is illustrated in FIG. 2 that is described below corresponds to a situation in which this kind of problem arises. The reason why sampling data that is synchronized with the crank angle is required as in-cylinder pressure data for combustion analysis is that the in-cylinder volume V is required for the combustion analysis, and the crank angle is required to calculate the in-cylinder volume V.

FIG. 2 is a time chart that represents operations at ignition start-up.

Ignition start-up is a start-up method in which fuel injection and ignition are performed as shown in FIG. 2(A) with respect to a cylinder that has stopped at its expansion stroke to thereby cause combustion to occur in the cylinder, and thus starts up (restarts) the internal combustion engine 10 without using a starter motor by rotationally driving the crankshaft 58 with the pressure of the combustion. In the case of ignition start-up, the combustion ends during a period in which the crankshaft 58 rotates by a very small amount (amount corresponding to a crank angle of around 10° as shown in FIG. 2(B)). As a result, a sampling interval of in-cylinder pressure data (denoted by white circles) that is synchronized with the crank angle lengthens with respect to changes in the in-cylinder pressure as shown in FIG. 2(A), and a combustion waveform can not be reliably captured. Consequently, with respect to in-cylinder heat release amounts calculated by analysis that uses such kind of in-cylinder pressure data, as shown in FIG. 2(C), it is not possible to acquire data for a rise in the heat release amount or the vicinity of a maximum heat release amount. Therefore, it appears as though combustion is not occurring. As described above, in a case where the engine rotational speed is sufficiently low with respect to a combustion period, as at ignition start-up, since it is not possible to sufficiently sample the in-cylinder pressure during combustion, the accuracy of the sampled in-cylinder pressure data is poor, and therefore the accuracy of the combustion analysis that uses the in-cylinder pressure data also deteriorates.

As a countermeasure for the above described problem, technology is known that, when the engine rotational speed is low, performs sampling of the in-cylinder pressure that is synchronized with the time instead of performing sampling that is synchronized with the crank angle. However, sampling of in-cylinder pressure data for capturing an in-cylinder pressure waveform at the time of combustion is also influenced by the combustion speed and not just the engine rotational speed. Even if the engine rotational speed stays the same, the combustion speed changes according to, for example, the operating state of the internal combustion engine. More specifically, the intake air amount, intake air temperature, in-cylinder temperature, engine cooling water temperature, fuel properties (heavy/light, alcohol concentration), air pressure, ignition timing, air-to-fuel ratio, injection timing, fuel pressure, external EGR gas amount, internal EGR gas amount (EGR gas amount obtained by adjusting the valve timing), valve timing, valve working angle and the like may be mentioned as factors that cause the combustion temperature to change.

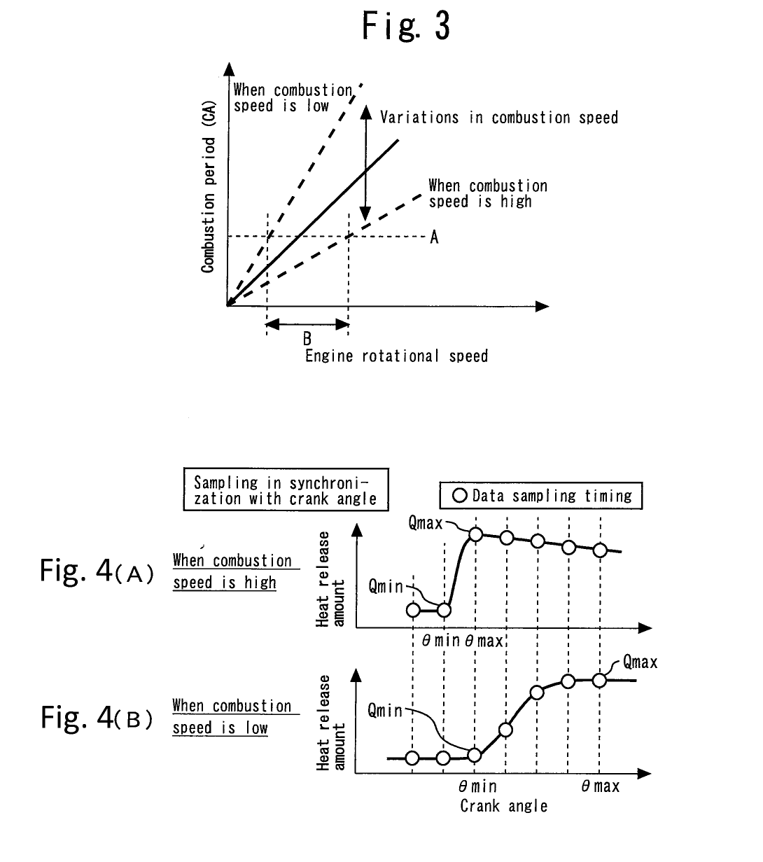

FIG. 3 is a view for describing variations in a guaranteed rotation speed with respect to the accuracy of sampling that is synchronized with the crank angle that are caused by variations in the combustion speed. A threshold value A of a combustion period shown in FIG. 3 denotes a combustion period in which it is possible to perform adequate sampling of in-cylinder pressure data that is synchronized with the crank angle in a predetermined crank angle interval. On the other hand, as shown as a rotation speed range B in FIG. 3, variations arise in the guaranteed rotation speed with respect to the accuracy of sampling that is synchronized with the crank angle that are caused by variations in the combustion speed.

FIG. 4 is a view that illustrates differences in heat release amount waveforms in accordance with changes in the combustion speed under the same engine rotational speed. As shown in FIG. 4, when the combustion speed is high (FIG. 4(A)), changes in the heat release amount that accompany combustion are abrupt in comparison to when the combustion speed is low (FIG. 4(B)). Thus, even when the engine rotational speed stays the same, depending on the combustion speed, differences arise in the number of items of in-cylinder pressure data that are sampled in a combustion period (θmin to θmax), and a case in which sampling of highly reliable in-cylinder pressure data can be performed and a case in which sampling of highly reliable in-cylinder pressure data cannot be performed can arise. Therefore, the following problem arises when a method is employed that switches between using and not using in-cylinder pressure data that is synchronized with the crank angle depending on merely the engine rotational speed. That is, in a case where a threshold value of an engine rotational speed at which to switch to sampling that is synchronized with the crank angle is set to a high value with the intention of ensuring highly reliable sampling of in-cylinder pressure data, even when it can be said that, depending on the combustion speed, reliability is actually ensured on the low engine rotational speed side, sampling of in-cylinder pressure data that is synchronized with the crank angle is not performed. Conversely, in a case where the threshold value of the engine rotational speed at which to switch to sampling that is synchronized with the crank angle is set to a low value, it is difficult to obtain sufficient accuracy in a combustion analysis result that is based on the acquired in-cylinder pressure data.

### Characteristic Determination Method for Determining Reliability of Sampling Data of In-Cylinder Pressure in First Embodiment

Accordingly, in the present embodiment, in-cylinder heat release amount data is calculated based on in-cylinder pressure data sampled in synchronization with the crank angle. Further, in the present embodiment, in a case where the number of items of heat release amount data located in a combustion period specified using heat release amount data is two or more, the in-cylinder pressure data that was sampled in synchronization with the crank angle is determined as reliable. More specifically, in a case where the number of items of heat release amount data located in a combustion period is two or more, it is determined that the in-cylinder pressure data that was sampled in synchronization with the crank angle has the required accuracy for combustion analysis (accuracy for calculating combustion state amounts).

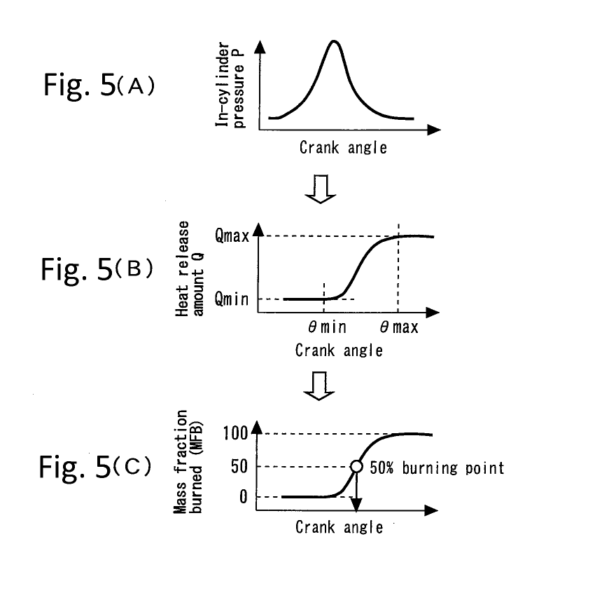

FIG. 5 is a view that illustrates basic waveforms with respect to the in-cylinder pressure P, the heat release amount Q, and the mass fraction burned MFB. As shown in FIG. 5(A), the waveform of the in-cylinder pressure P is a waveform that reaches a peak value as a result of combustion. As shown in FIG. 5(B), the waveform of the heat release amount Q can be calculated, for example, according to the following equations (2) and (3) based on the first law of thermodynamics shown in the following equation (1), using in-cylinder pressure data. In this case, the heat release amount Q at the start of combustion (that is, the minimum value of the heat release amount Q during one cycle) is taken as Qmin, the heat release amount Q at the end of combustion (that is, the maximum value of the heat release amount Q in one cycle) is taken as Qmax, a crank angle at the time of the minimum heat release amount Qmin is taken as a combustion start timing θmin, and a crank angle at the time of the maximum heat release amount Qmax is taken as a combustion end timing θmax. FIG. 5(C) shows a waveform of the mass fraction burned MFB that can be calculated based on the data of the heat release amount Q by taking a value at the time of the minimum heat release amount Qmin as 0% and taking a value of the time of the maximum heat release amount Qmax as 100%. If the waveform of the mass fraction burned MFB can be determined, a 50% burning point (combustion center of gravity) that is a crank angle when the mass fraction burned MFB becomes 50% can be calculated. Note that, in equation (1), U represents internal energy and W represents work. Also, in equation (2), θ represents a crank angle and x represents a specific heat ratio.

$$[ Math . 1 ]$$

$$\begin{matrix}d Q = d U + d W & ( 1 ) \\ d Q / d θ = \frac{1}{κ - 1} \times ( V \times \frac{d P}{d θ} + P \times κ \times \frac{d V}{d θ} ) & ( 2 ) \\ Q = \sum \frac{d Q}{d θ} & ( 3 )\end{matrix}$$

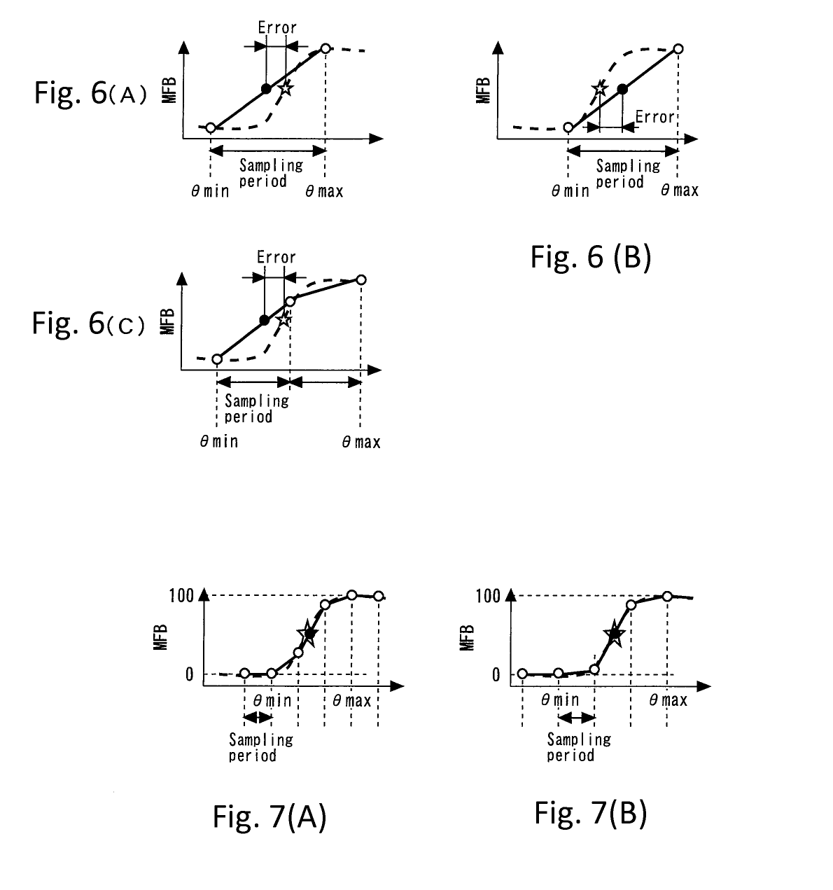

FIG. 6 is a view that illustrates combustion analysis examples in a case where less than two items of in-cylinder pressure data have been sampled in synchronization with the crank angle during a combustion period (θmin to θmax). More specifically, FIGS. 6(A) and (B) illustrate cases where not even one item of sampling data of the in-cylinder pressure has been acquired during the combustion period, and FIG. 6(C) illustrates a case where only one item of sampling data of the in-cylinder pressure has been acquired during the combustion period. In these cases, there is a large error with respect to a 50% burning point (black circle) calculated based on the sampled in-cylinder pressure data relative to a true 50% burning point (star mark) for a true mass fraction burned MFB (broken line). In cases such as these in which the number of items of sampling data for the in-cylinder pressure during a combustion period is less than two, it cannot be said that the combustion analysis result (in this case, the result of calculating the 50% burning point) is sufficiently accurate. Accordingly, in such a case, it can be determined that the sampled in-cylinder pressure data that was synchronized with the crank angle is not reliable (the data does not have sufficient accuracy for combustion analysis).

FIG. 7 is a view that illustrates combustion analysis examples in a case where two or more items of in-cylinder pressure data have been sampled in synchronization with the crank angle during the combustion period (θmin to θmax). More specifically, FIGS. 7(A) and (B) each illustrate a case in which two items of sampling data of the in-cylinder pressure have been acquired during the combustion period. In these cases, an error with respect to a 50% burning point (black circle) that is calculated based on the sampled in-cylinder pressure data is sufficiently small relative to a true 50% burning point (star mark). Thus, it is found that in cases such as these in which the number of items of sampling data for the in-cylinder pressure during a combustion period is two or more, the combustion analysis result (in this case, the result of calculating the 50% burning point) has sufficient accuracy. The section at which the amount of change in the heat release amount Q is largest is from Qmin to Qmax, and it can be considered that if two items of sampling data have been acquired during the combustion period (θmin to θmax) that corresponds thereto, data have also been acquired in the vicinity of the maximum heat release amount Q max at which the amount of change is small. Accordingly, in a case where the number of items of sampling data of the in-cylinder pressure during a combustion period is two or more, it can be determined that the in-cylinder pressure data sampled in synchronization with the crank angle is reliable (the data has sufficient accuracy for combustion analysis).

Furthermore, as described above, according to the present embodiment a configuration is adopted in which the in-cylinder pressure data sampled in synchronization with the crank angle is not used directly, but instead a heat release amount Q is calculated based on the sampling data for the in-cylinder pressure, and thereafter whether or not the sampling data is reliable (accurate) is determined utilizing a result of determining whether or not the number of items of heat release amount data during the combustion period is two or more. As shown in FIG. 5(B), the waveform of the heat release amount Q has a so-called “Z characteristic” (characteristic that the value changes stepwise in a manner in which the heat release amount Q changes abruptly during a combustion period). When it is attempted to reliably reproduce a waveform of the heat release amount Q having such a characteristic with heat release amount data distributed based on sampling data of the in-cylinder pressure, a waveform of the heat release amount Q cannot be reliably reproduced if the number of items of heat release amount data during the combustion period is less than two, and it is necessary for the number of items of heat release amount data sampled during the combustion period to be two or more. Consequently, as described in the foregoing, when the number of items of sampling data of the in-cylinder pressure during a combustion period is two or more, it can be determined that the in-cylinder pressure data sampled in synchronization with the crank angle is reliable (has sufficient accuracy for combustion analysis).

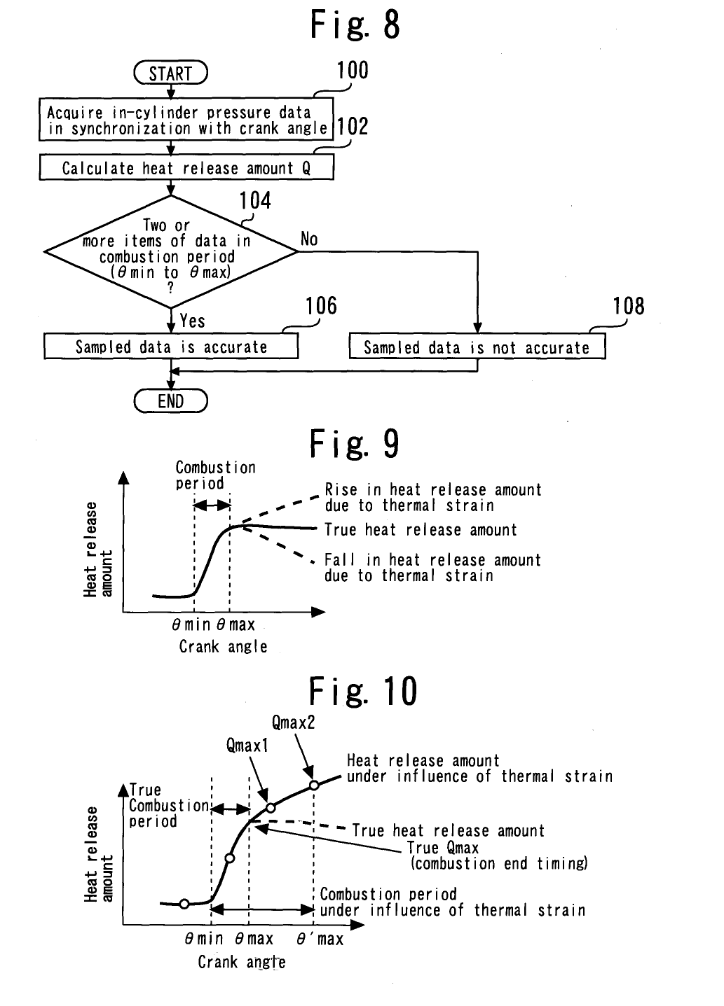

FIG. 8 is a flowchart illustrating a routine that the ECU 50 executes to realize the characteristic determination of the reliability of sampling data of the in-cylinder pressure according to the first embodiment of the present invention. It is assumed that the present routine is repeatedly executed at each cycle in the respective cylinders.

According to the routine shown in FIG. 8, first, using the in-cylinder pressure sensor 34 and the crank angle sensor 52, the ECU 50 acquires in-cylinder pressure data in synchronization with the crank angle (step 100). Next, the ECU 50 utilizes the acquired in-cylinder pressure data to calculate data for the heat release amount Q that is synchronized with the crank angle (step 102).

The ECU 50 then determines whether or not the number of items of data of the heat release amount Q during a combustion period (θmin to θmax) is two or more (step 104). The combustion start timing θmin and the combustion end timing θmax for defining the combustion period can be identified, for example, by the following method. That is, the combustion start timing θmin can be identified utilizing the crank angle of a data item that is one item prior to a data item in which the heat release amount Q first rose from zero among the data items for the heat release amount Q. Further, the combustion end timing θmax can be identified, for example, utilizing the crank angle of a data item (data item at which the heat release amount Q reaches a maximum) that is one item prior to a data item at which a change in the heat release amount Q stops after the heat release amount Q has risen.

If it is determined in the aforementioned step 104 that the number of items of data of the heat release amount Q during the combustion period is two or more, the ECU 50 determines that the in-cylinder pressure data sampled in synchronization with the crank angle is reliable (more specifically, the sampled in-cylinder pressure data has the accuracy required for combustion analysis (required for calculating combustion state amounts)) (step 106). In contrast, if it is determined that the number of items of data of the heat release amount Q sampled during the combustion period is not two or more, the ECU 50 determines that the in-cylinder pressure data sampled in synchronization with the crank angle is not reliable (more specifically, the sampled in-cylinder pressure data does not have the accuracy required for combustion analysis (required for calculating combustion state amounts)) (step 108).

According to the routine illustrated in FIG. 8 that is described above, the reliability of sampling data of the in-cylinder pressure can be determined regardless of the engine rotational speed or the combustion speed. Consequently, even in a low engine rotational speed region in which combustion analysis cannot be performed according to the conventional method which is configured to uniformly not use sampling data synchronized with the crank angle in a case where the engine rotational speed is lower than a predetermined value, according to the above described routine, combustion analysis can be performed on the condition that it is determined that the sampling data is reliable. Thus, in comparison to the conventional method, it is possible to increase the opportunities to implement various kinds of engine control and the like that utilize a combustion analysis result.

Note that, in the above described first embodiment, “heat release amount data calculation means” according to the above described first aspect of the present invention is realized by the ECU 50 executing the processing in the above described steps 100 and 102, and “data reliability determination means” according to the first aspect of the present invention is realized by the ECU 50 executing the processing in the above described steps 104 to 108.

### Second Embodiment

Next, a second embodiment of the present invention will be described referring mainly to FIGS. 9 to 12.

The system of the present embodiment can be implemented by using the hardware configuration shown in FIG. 1 and causing the ECU 50 to execute a routine illustrated in FIG. 12 that is described later instead of the routine illustrated in FIG. 8.

### Problem Relating to Method of Determining Reliability of Sampling Data of In-Cylinder Pressure in First Embodiment

FIG. 9 and FIG. 10 are views for describing a problem relating to the determination method of the first embodiment that is described above.

As shown by a solid line in FIG. 9, in a waveform of the true heat release amount Q, after passing the combustion end timing θmax, the heat release amount Q tends to be constant or to decrease slightly. A distortion that is caused by factors such as thermal strain at a pressure-receiving portion can arise in an output waveform of an in-cylinder pressure sensor. In a case where an output waveform of an in-cylinder pressure sensor is affected by thermal strain or the like, variations arise in the waveform of the heat release amount Q after passing the combustion end timing θmax. More specifically, as shown by broken lines in FIG. 9, in some cases the heat release amount Q rises after passing the combustion end timing θmax and in some cases the heat release amount Q decreases after passing the combustion end timing θmax.

In a case where the heat release amount Q decreases after passing the combustion end timing θmax, since the crank angle position at which the maximum heat release amount Q max is obtained does not itself change significantly, it can be said that a problem does not arise even if the combustion period (θmin to θmax) identified by the above described method of the first embodiment is used to determine the reliability of sampling data.

In contrast, in a case where the heat release amount Q continues to rise after passing the combustion end timing θmax, it is difficult to simply identify which heat release amount data item is the data of the maximum heat release amount Qmax. Consequently, taking FIG. 10 as an example to describe this situation, there is a possibility that a heat release amount Qmax1 that it is preferable to adopt as the maximum heat release amount Qmax in this example will not be adopted as the maximum heat release amount Qmax, and instead a heat release amount Qmax2 that is one data item after the heat release amount Qmax1 will be regarded as the maximum heat release amount Qmax. If the heat release amount Qmax2 is regarded as the maximum heat release amount Qmax, a period (θmin to θ′max) will be regarded as the combustion period. If the period (θmin to θ′max) is used as the combustion period, even though only one item of sampling data has been acquired in the true combustion period (θmin to θmax), it will be determined that two items of sampling data have been acquired, which will result in an erroneous determination that the sampling data is reliable.

### Characteristic Method of Determining Reliability of Sampling Data of In-Cylinder Pressure in Second Embodiment

In the present embodiment, the following determination method is used to enable a determination as to whether or not two items or more of heat release amount data (based on sampling data of the in-cylinder pressure P) have been acquired during a combustion period even when variations arise in the waveform of the heat release amount Q due to the influence of thermal strain or the like.

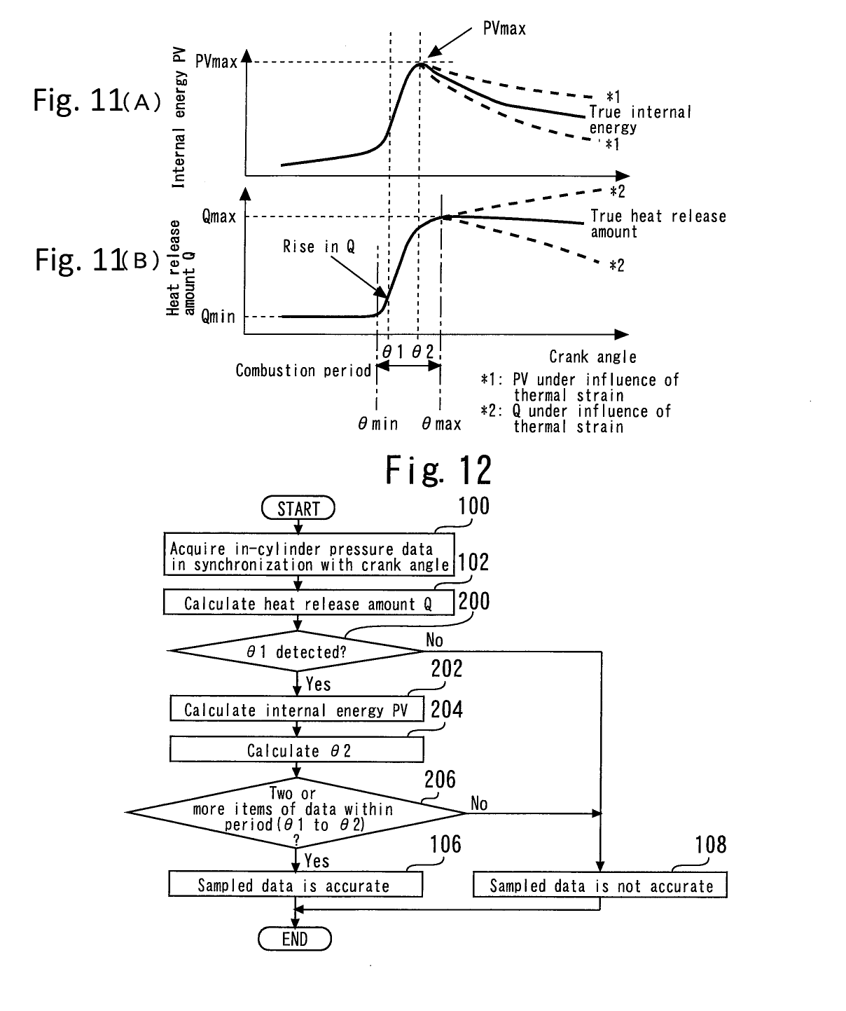

FIG. 11 is a view illustrating changes in an internal energy PV and the heat release amount Q with respect to the crank angle, respectively.

The internal energy PV of in-cylinder gas is a parameter that is proportional to the in-cylinder temperature, as will also be understood from the equation of state of gas (PV=nRT). This reveals that a crank angle position (hereunder, referred to as “second crank angle θ2”) at which the internal energy exhibits a maximum value PVmax is a point at which the in-cylinder temperature exhibits a maximum value, and is during combustion. That is, it can be said that, as will also be understood from FIG. 11, the second crank angle θ2 at which PVmax is obtained is always before the combustion end timing θmax.

Further, similarly to the waveform of the heat release amount Q, a waveform of the internal energy PV is influenced by thermal strain and the like. However, as shown in FIG. 11(A), the waveform of the internal energy PV is influenced by thermal strain and the like after the internal energy maximum value PVmax has been passed, and hence the second crank angle θ2 at which PVmax is obtained does not change even if thermal strain occurs. Therefore, the second crank angle θ2 at which PVmax is obtained is always included in the true combustion period irrespective of the existence or non-existence of thermal strain or the like.

In addition, according to the present embodiment a configuration is adopted so as to define, as a crank angle θ1, a first crank angle of a data item at which the heat release amount first rises from the minimum heat release amount Qmin among items of heat release amount data based on sampled in-cylinder pressure data. It can be said that the first crank angle θ1 defined in this manner is always after the combustion start timing θmin.

Further, according to the present embodiment, it is then determined whether or not two or more items of heat release amount data are located within a period (θ1 to θ2) that is at or after the first crank angle θ1 and is at or before the second crank angle θ2 that are identified as described above. If two or more items of heat release amount data are located within the period (θ1 to θ2), it is determined that two or more items of heat release amount data have been acquired during the true combustion period (θmin to θmax).

As described above, it can be said the first and second crank angles θ1 and θ2 are included in the true combustion period (θmin to θmax). Therefore, if two or more items of heat release amount data are located within the period (θ1 to θ2), naturally it can be determined that two or more items of heat release amount data have been acquired during the true combustion period (θmin to θmax). Thus, according to the above described determination method, regardless of whether or not variations arise in a waveform of the heat release amount Q due to the influence of thermal strain or the like, it is possible to accurately determine whether or not two or more items of heat release amount data (sampling data) have been acquired during the true combustion period (θmin to θmax). Consequently, regardless of whether or not variations arise in a waveform of the heat release amount Q due to the influence of thermal strain or the like, it is possible to accurately determine whether or not in-cylinder pressure data sampled in synchronization with the crank angle is reliable.

FIG. 12 is a flowchart illustrating a routine that the ECU 50 executes to realize the characteristic determination of the reliability of sampling data of the in-cylinder pressure according to the second embodiment of the present invention. It is assumed that the present routine is repeatedly executed at each cycle in the respective cylinders. Further, in FIG. 12, steps that are the same as steps in FIG. 8 according to the first embodiment are denoted by the same reference numerals, and a description of those steps is omitted or simplified below.

In the routine shown in FIG. 12, after calculating data for the heat release amount Q in step 102, the ECU 50 determines whether or not the aforementioned first crank angle θ1 has been detected (step 200). If the first crank angle θ1 has not yet been detected, the ECU 50 determines that the in-cylinder pressure data that was sampled in synchronization with the crank angle is not reliable (does not have the accuracy required for combustion analysis) (step 108).

On the other hand, if the first crank angle θ1 has been detected, the ECU 50 then uses in-cylinder pressure data and in-cylinder volume data to calculate data for the internal energy PV that is synchronized with the crank angle (step 202). Next, the ECU 50 acquires a maximum value among the calculated internal energy PV data as an internal energy maximum value PVmax, and calculates the crank angle with respect to the value PVmax as the second crank angle θ2 (step 204).

Next, the ECU 50 determines whether or not two or more items of heat release amount data are located within a period (θ1 to θ2) that is at or after the first crank angle θ1 and is at or before the second crank angle θ2 (step 206). If it is determined as a result that two or more items of heat release amount data are located within the period (θ1 to θ2), that is, if it can be determined that two or more items of heat release amount data have been acquired in the true combustion period (θmin to θmax), the ECU 50 determines that the in-cylinder pressure data that was sampled in synchronization with the crank angle is reliable (has the accuracy necessary for combustion analysis) (step 106). In contrast, if the number of items of heat release amount data in the period (θ1 to θ2) is less than two, since there is a high possibility that two or more items of heat release amount data have not been acquired in the true combustion period (θmin to θmax), the ECU 50 determines that the in-cylinder pressure data that was sampled in synchronization with the crank angle is not reliable (does not have the accuracy necessary for combustion analysis) (step 108).

Note that, in the above described second embodiment, “data reliability determination means” according to the above described first, eighth and ninth aspects of the present invention is realized by the ECU 50 executing the processing in the above described steps 200 to 206, 106 and 108.

### Third Embodiment

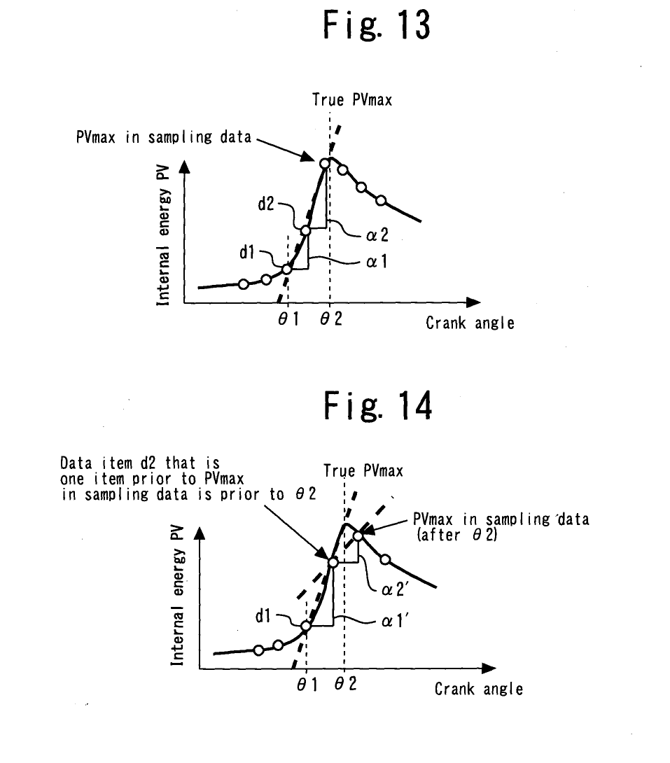

Next, a third embodiment of the present invention will be described referring mainly to FIGS. 13 to 19.

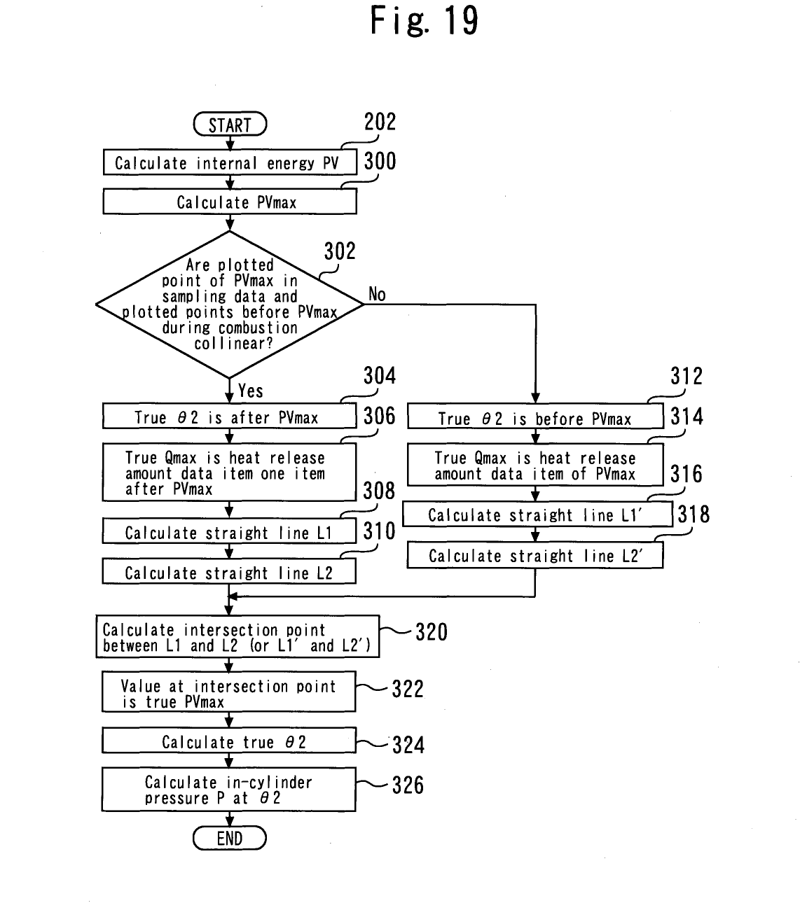

The system of the present embodiment can be implemented by using the hardware configuration shown in FIG. 1 and causing the ECU 50 to execute a routine illustrated in FIG. 19 that is described later as well as the routine illustrated in FIG. 12.

### Method for Determining if Heat Release Amount Data is Data before True Second Crank Angle θ2

In the above described second embodiment, a configuration is adopted that acquires, as the second crank angle θ2, a crank angle with respect to a maximum value in the calculated internal energy PV data (hereunder, may be referred to as “PVmax in the sampling data”). However, as shown in FIG. 13 and FIG. 14 that are described later, in some cases the crank angle with respect to PVmax in the sampling data may be before or after the true second crank angle θ2 with respect to the true PVmax. Therefore, according to the present embodiment the method described hereunder is used to make it possible to determine with certainty whether heat release amount data (sampling data) is data before the true second crank angle θ2.

FIG. 13 and FIG. 14 are views for describing the method for determining if heat release amount data is data before the true second crank angle θ2 (that is, data acquired during combustion). As described above, the first crank angle θ1 can be acquired using the crank angle with respect to a data item at which the heat release amount Q first rises from the minimum heat release amount Qmin. After acquiring the first crank angle θ1, according to the present embodiment, as shown in FIG. 13, it is determined whether or not a plotted point of PVmax in the sampling data and plotted points of data items that are at or after the first crank angle θ1 and before the plotted point of PVmax are collinear.

FIG. 13 illustrates an example in which a plotted point of PVmax in the sampling data and plotted points of data items that are at or after the first crank angle θ1 and before the plotted point of PVmax (total of three points in the example shown in FIG. 13) are collinear. According to the present embodiment, in this case it is determined that PVmax in the sampling data is data before the true second crank angle θ2 with respect to the true PVmax, that is, is data acquired during combustion. As will also be understood from FIG. 11(A) and the like, a waveform of the internal energy PV rises in a straight line after the start of combustion, and exhibits a maximum value PVmax immediately after the waveform of the internal energy PV stops rising. Therefore, as shown in FIG. 13, it can be said that the true second crank angle θ2 with respect to the true PVmax is located at a position that is immediately after the aforementioned straight line and is separated therefrom, and accordingly the above described determination is possible.

Whether or not data items with respect to the internal energy PV are collinear as shown in FIG. 13 can be determined, for example, by the following method. That is, taking the case illustrated in FIG. 13 as an example, when a difference between an inclination α1 of a straight line that links a plotted point of an item of data d1 of the internal energy PV at the first crank angle θ1 and a plotted point of an item of data d2 that is one item after the item of data d1 and an inclination α2 of a straight line that links the plotted point of the item of data d2 and a plotted point of PVmax in the sampling data is equal to or less than a predetermined value, it can be determined that the plotted points of the (three) items of data that are the determination objects are on a straight line. Note that processing in a case when the number of data items that are the determination objects is other than three (however, is equal to or greater than two) is also similar to the above described processing, and is performed by calculating the respective inclinations between plotted points of each two items of data that are adjacent, and determining whether or not differences between all of the calculated inclinations are less than or equal to a predetermined value.

On the other hand, FIG. 14 illustrates an example in which a plotted point of PVmax in the sampling data and plotted points that are at or after the first crank angle θ1 (total of three points in the example shown in FIG. 14) and before PVmax are not collinear. That is, according to this example, since a difference between an inclination α1′ and an inclination α2′ is greater than the aforementioned predetermined value it can be determined that the plotted points of the data items that are the determination objects are not on a straight line. In this case, it is found that PVmax in the sampling data is a data item for a crank angle that is at or after the true second crank angle θ2 with respect to the true PVmax. Consequently, according to the present embodiment, in this case it is determined that a data item that is one item prior to the data item of PVmax in the sampling data is a data item that is before the true second crank angle θ2 with respect to the true PVmax, that is, is an item of data acquired during combustion.

As described above, according to the method illustrated in FIG. 13 and FIG. 14 it is possible to determine whether or not a specific item of heat release amount data (sampling data) is a data item acquired during a true combustion period. In order words, the positional relationship of a specific item of heat release amount data (sampling data) with respect to the true combustion end timing θmax can be accurately determined.

Note that, the method illustrated in FIG. 13 and FIG. 14 can also be described in another way as follows. That is, the method determines whether or not respective plotted points of data items of the internal energy PV that are at or after the first crank angle θ1 are on a single straight line. Further, in a case where a data item at which the internal energy PV exhibits a maximum value among the points that are on the single straight line is a data item for PVmax, it is determined that PVmax in the sampling data is data acquired before the true second crank angle θ2, that is, is data acquired during combustion. In contrast, if the data item for PVmax is not on the single straight line, it is determined that a data item that is one item prior to the data item for PVmax in the sampling data is data acquired before the true second crank angle θ2, that is, data acquired during combustion.

### Method for Estimating True PVmax and True Second Crank Angle θ2

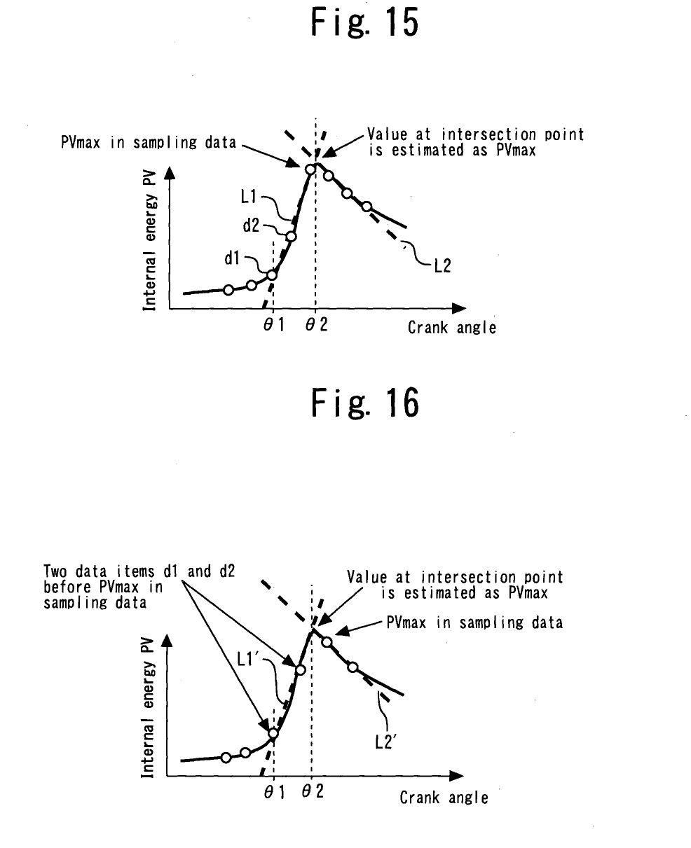

FIG. 15 and FIG. 16 are views for describing a method that estimates the true PVmax and the true second crank angle θ2 using data for the internal energy PV that was calculated utilizing sampling data of the in-cylinder pressure.

FIG. 15 corresponds to the example illustrated in FIG. 13 that is described above, and illustrates an example in which a plotted point of PVmax in the sampling data and plotted points of data items d1 and d2 that are at or after the first crank angle θ1 and before the plotted point of PVmax (total of three points in the example shown in FIG. 15) are collinear. According to the present embodiment, it is estimated in this case that a value at an intersection point between a straight line L1 that passes through the aforementioned three points and a straight line L2 that passes through plotted points of two items of data that are after PVmax in the sampling data is the true PVmax, and a crank angle with respect to this value is the true second crank angle θ2. Note that, it is sufficient that the straight line L1 is a straight line passing through any two points among the plotted points of data items that are at or before PVmax in the sampling data and at or after the first crank angle θ1 (in this case, if three or more plotted points exist, an approximate straight line concerning the three or more plotted points is regarded as corresponding thereto). Consequently, in the above described example, a straight line that passes through a total of two points consisting of the plotted point of PVmax in the sampling data and the plotted point of the data item d1 or d2 may be used, or a straight line that passes through a total of two points consisting of the plotted point of the data item d1 and the plotted point of the data item d2 may be used.

FIG. 16 corresponds to the example shown in FIG. 14 that is described above, and illustrates an example in which a plotted point of PVmax in the sampling data, and plotted points of the data items d1 and d2 that are at or after the first crank angle θ1 and before PVmax in the sampling data (total of three points in the example shown in FIG. 16) are not collinear. In this case, as described above referring to FIG. 14, the true PVmax is before PVmax in the sampling data. Therefore, according to the present embodiment, in this case it is estimated that a value at an intersection point between a straight line L1′ that passes through the plotted points of the two items of data (data after combustion starts) that are before PVmax in the sampling data and a straight line L2′ that passes through the plotted point of PVmax in the sampling data and a plotted point of a data item that is one item after PVmax in the sampling data is the true PVmax, and a crank angle at this value is the true second crank angle θ2. Note that, it is sufficient that the straight line L1′ is a straight line passing through any two points among the plotted points of data items that are before PVmax in the sampling data and at or after the first crank angle θ1 (in this case, if three or more plotted points exist, an approximate straight line concerning the three or more plotted points is regarded as corresponding thereto).

According to the method illustrated in FIG. 15 and FIG. 16 described above, it is possible to accurately estimate the true PVmax and the true second crank angle θ2 utilizing a relative positional relationship between data (sampling data) of the internal energy PV.

### Calculation of In-Cylinder Pressure P at True Second Crank Angle θ2 at which True PVmax is Obtained

Further, according to the present embodiment the in-cylinder pressure P at the true second crank angle θ2 is calculated utilizing the true PVmax and the true second crank angle θ2 that are estimated by the method described above with reference to FIG. 15 and FIG. 16. Since the product of the in-cylinder pressure P and the in-cylinder volume V is known based on the true PVmax, and the true second crank angle θ2 is known, the in-cylinder volume V at the true second crank angle θ2 can be calculated. Accordingly, the in-cylinder pressure P at the true second crank angle θ2 can be calculated by means of the calculated in-cylinder volume V and the true PVmax. It is thereby possible to increase the number of data items for the in-cylinder pressure P by one item when performing combustion analysis utilizing sampling data of the in-cylinder pressure.

### Method for Identifying Maximum Heat Release amount Qmax Data

As described above referring to FIG. 10 in the second embodiment, when factors such as thermal strain that cause variations in the in-cylinder pressure waveform have arisen, the crank angle position with respect to the maximum heat release amount Qmax becomes inaccurate. The influence of such an inaccuracy is expressed as an error in calculation of combustion analysis values such as the mass fraction burned MFB or the 50% burning point (CA50).

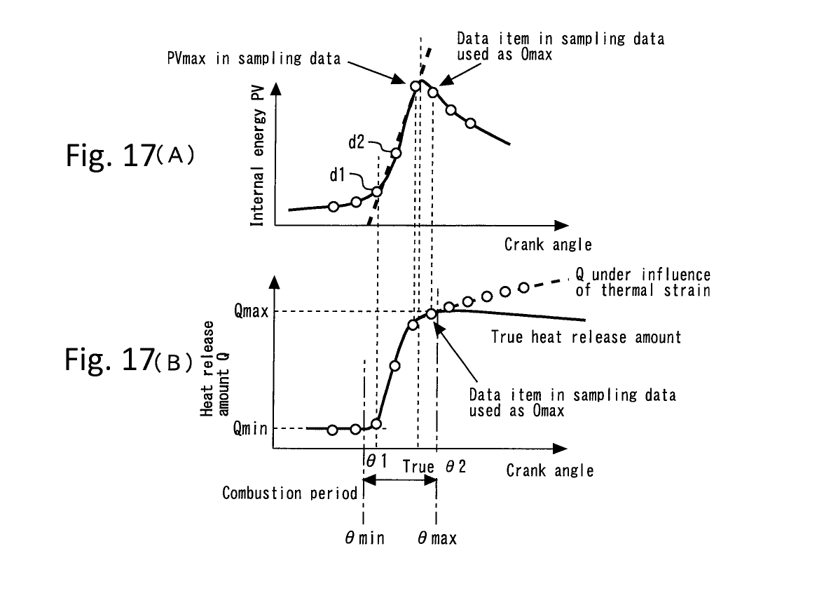

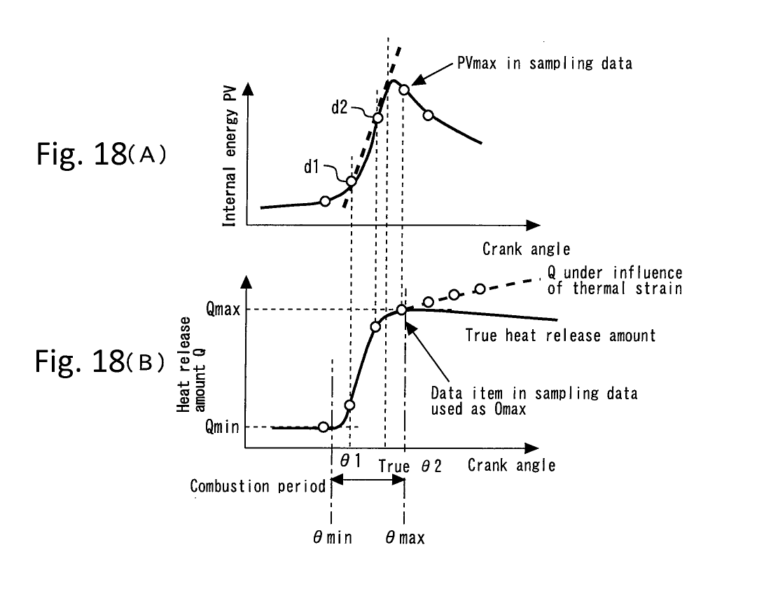

FIG. 17 and FIG. 18 are views for describing a method of identifying data of the maximum heat release amount Qmax.

FIG. 17 corresponds to the example illustrated in FIG. 13 described above, and illustrates an example in which a plotted point of PVmax in the sampling data and plotted points of data items d1 and d2 that are before PVmax in the sampling data and at or after the first crank angle θ1 (total of three points in the example shown in FIG. 17) are collinear. As described in the foregoing, in this case it is identified that the true second crank angle θ2 is after PVmax in the sampling data. Therefore, according to the present embodiment a configuration is adopted that, utilizing this fact, uses a heat release amount data item that is one item after PVmax in the sampling data as the data of the maximum heat release amount Qmax.

According to this example, PVmax in the sampling data is data acquired before the true second crank angle θ2, that is, data acquired during combustion. Consequently, it can be said that rather than using a heat release amount data item corresponding to PVmax in the sampling data as the data of the maximum heat release amount Qmax, it is more appropriate to use a heat release amount data item that is one item after PVmax in the sampling data as the data of the maximum heat release amount Qmax. Thus, according to this identification method, it is possible to accurately identify the data of the maximum heat release amount Qmax regardless of whether or not variations arise in the waveform of the heat release amount Q due to the influence of thermal strain and the like, by using heat release amount data that is close to the true combustion end timing θmax (crank angle with respect to the true maximum heat release amount Qmax) that arrives immediately after the true PVmax.

However, in the example illustrated in FIG. 17, there are also cases in which it can be said that, depending on the operating state of the internal combustion engine 10, an item of heat release amount data that is two items after PVmax in the sampling data is an item that is closest to the true maximum heat release amount Qmax. Therefore, in a case where PVmax in the sampling data is data acquired before the true second crank angle θ2 as in the example shown in FIG. 17, a configuration may be adopted that uses a heat release amount data item that is one item or two items after PVmax in the sampling data as the data of the maximum heat release amount Qmax, and changes which of these data items to use in accordance with the operating state.

FIG. 18 corresponds to the example illustrated in FIG. 14 described above, and illustrates an example in which a plotted point of PVmax in the sampling data and plotted points of data items d1 and d2 that are before PVmax in the sampling data and at or after the first crank angle θ1 (total of three points in the example shown in FIG. 18) are not collinear. As described in the foregoing, in this case it is identified that the true second crank angle θ2 is before PVmax in the sampling data. Therefore, according to the present embodiment a configuration is adopted that, utilizing this fact, uses an item of heat release amount data that corresponds to PVmax in the sampling data as the data of the maximum heat release amount Qmax. In this case, by utilizing the heat release amount data corresponding to PVmax in the sampling data that is data acquired immediately after the true second crank angle θ2, it is possible to accurately identify the data of the maximum heat release amount Qmax regardless of whether or not variations arise in the heat release amount waveform due to the influence of thermal strain and the like, by using heat release amount data that is close to the true combustion end timing θmax (crank angle with respect to the true maximum heat release amount Qmax) that arrives immediately after the true PVmax.

However, in the example illustrated in FIG. 18, there are also cases in which it can be said that, depending on the operating state of the internal combustion engine 10, an item of heat release amount data that is one item after a heat release amount data item corresponding to PVmax in the sampling data is an item that is closest to the true maximum heat release amount Qmax. Therefore, in a case where PVmax in the sampling data is data acquired after the true second crank angle θ2 as in the example shown in FIG. 18, a configuration may be adopted that uses, as the data of the maximum heat release amount Qmax, a heat release amount data item corresponding to PVmax in the sampling data or a heat release amount data item that is one item thereafter, and changes which of these data items to use in accordance with the operating state.

FIG. 19 is a flowchart illustrating a routine that the ECU 50 executes to realize the above described characteristic determination according to the third embodiment of the present invention. It is assumed that the present routine is repeatedly executed at each cycle in the respective cylinders in parallel with the routine illustrated in FIG. 12. It is also assumed that results obtained by the processing of the routine illustrated in FIG. 19 are reflected in processing of the routine illustrated in FIG. 12. Specifically, processing in step 304 or 312 that is described later (result of determining position of PVmax in the sampling data) is utilized in the determination in step 206 that is described above. Further, a true second crank angle θ2 estimated in step 324 that is described later may be utilized in the determination in step 206 that is described above.

In the routine shown in FIG. 19, after calculating data for the internal energy PV that is synchronized with the crank angle using in-cylinder pressure data and in-cylinder volume data in the aforementioned step 202, the ECU 50 calculates a maximum value in the data, that is, PVmax in the sampling data (step 300).

Next, using the method described above with reference to FIG. 13 and FIG. 14, the ECU 50 determines whether or not a plotted point of PVmax in the sampling data and plotted points of data items for the internal energy PV that are before the plotted point of PVmax and at or after the first crank angle θ1 (total of three points in the example shown in FIG. 13) are collinear (step 302).

If the result determined in step 302 is that the data items are collinear, the ECU 50 determines that the true second crank angle θ2 is after PVmax in the sampling data, that is, that PVmax in the sampling data is data acquired during combustion (step 304).

Next, the ECU 50 takes a heat release amount data item that is one item after PVmax in the sampling data as the true maximum heat release amount Qmax (step 306). Thereafter, the ECU 50 calculates a straight line L1 that passes through the plotted point of PVmax in the sampling data and a plotted point of a data item that is one item before PVmax in the sampling data (step 308), and also calculates a straight line L2 that passes through the plotted points of the two data items after PVmax in the sampling data (step 310).

In contrast, if it is determined in the aforementioned step 302 that the above described data items are not collinear, the ECU 50 determines that the true second crank angle θ2 is before PVmax in the sampling data, that is, that a data item that is one item before PVmax in the sampling data is data acquired during combustion (step 312).

Next, the ECU 50 takes a heat release amount data item that corresponds to PVmax in the sampling data as the true maximum heat release amount Qmax (step 314). Thereafter, the ECU 50 calculates a straight line L1′ that passes through the plotted points of the two data items before PVmax in the sampling data (step 316), and also calculates a straight line L2′ that passes through the plotted point of PVmax in the sampling data and a plotted point of a data item that is one item after PVmax in the sampling data (step 318).

Next, the ECU 50 calculates an intersection point between the straight line L1 and the straight line L2, or an intersection point between the straight line L1′ and the straight line L2′ (step 320). Thereafter, the ECU 50 takes a value of the internal energy at the calculated intersection point as the true PVmax (step 322), and also takes a crank angle at the intersection point as the true second crank angle θ2 (step 324). Next, the ECU 50 utilizes the calculated true PVmax and true second crank angle θ2 to calculate the in-cylinder pressure P at the true second crank angle θ2 (step 326).

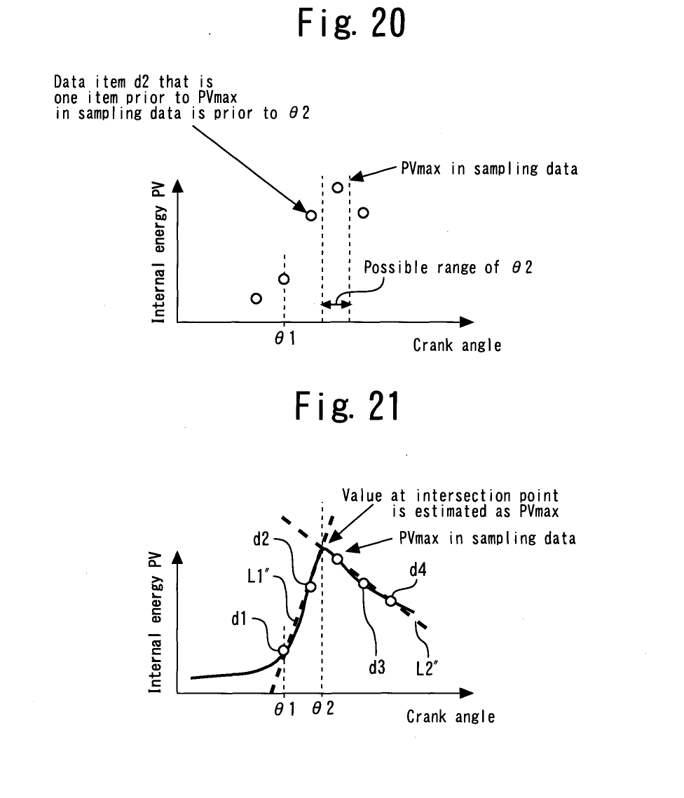

In this connection, in the above described third embodiment, as described with reference to FIG. 13 and FIG. 14, a configuration is adopted that determines the position of PVmax in the sampling data with respect to the true second crank angle θ2 based on whether or not a plotted point of PVmax in the sampling data and a plotted point of an item of data that is before PVmax in the sampling data and is at or after the first crank angle θ1 are collinear. However, a configuration may also be adopted so as to use, for example, the method described hereunder with reference to FIG. 20 instead of the above described method or together therewith.

FIG. 20 is a view for describing another method of determining heat release amount data during a combustion period.

As shown in FIG. 20, there is a possibility that the true second crank angle θ2 is located either before or after PVmax in the sampling data, or coincides with PVmax in the sampling data. However, a situation does not arise in which the position of the true second crank angle θ2 is before an item of data d2 that is the data item that is one item before PVmax in the sampling data. This is because, in order for the true PVmax to be located before the item of data d2, it would be necessary for the item of data d2 to be data for a larger value of the internal energy PV than PVmax in the sampling data that is shown in FIG. 20, and thus a contradiction would arise. Therefore, a configuration may be adopted in which, after calculating a maximum value (PVmax in the sampling data) among the data for the internal energy PV that was calculated based on the sampling data of the in-cylinder pressure P, it is determined that the item of data d2 that is the data item that is one item prior to PVmax in the sampling data that was calculated is a data item before the true second crank angle θ2, that is, is data acquired during combustion. According to this method, although it cannot be determined whether or not PVmax in the sampling data is itself before the true second crank angle θ2, unlike the method described in the third embodiment, identification of a heat release amount data item that was acquired during a combustion period can be performed without the necessity to determine whether or not a plurality of data items are on a straight line.

Further, in the above third embodiment a configuration is adopted that, as described with reference to FIG. 15 and FIG. 16, estimates the true PVmax and the true second crank angle θ2 utilizing an intersection point between a straight line L1 (L1′) and a straight line L2 (L2′) that were calculated using PVmax in the sampling data and data for the internal energy PV before and after PVmax in the sampling data. However, a configuration may also be adopted so as to use, for example, the method described hereunder with reference to FIG. 21 instead of the above described method or together therewith.

FIG. 21 is a view for describing another method for estimating the true PVmax and the true second crank angle θ2 using data for the internal energy PV calculated utilizing sampling data of the in-cylinder pressure.

According to the method illustrated in FIG. 21, first, a maximum value (PVmax in the sampling data) is calculated among the data for the internal energy PV calculated based on sampling data of the in-cylinder pressure P. Thereafter, as shown in FIG. 21, the true PVmax and the true second crank angle θ2 are estimated utilizing an intersection point between a straight line L1″ that passes through plotted points of the two items of data (data d1 and d2) prior to PVmax in the sampling data and a straight line L2″ that passes through plotted points of the two items of data (data d3 and d4) after PVmax in the sampling data, with the straight lines L1″ and L2″ excluding PVmax in the sampling data. According to this method also, it is possible to accurately estimate the true PVmax and the true second crank angle θ2 utilizing a relative positional relationship between data (sampling data) of the internal energy PV.

Note that, in the above described third embodiment, “data reliability determination means” according to the above described first aspect of the present invention and the eighth to twelfth aspects of the present invention is realized by the ECU 50 executing the processing in the above described steps 200 to 206, 106, 108, 300 to 304, and 312 as well as the processing described with reference to FIG. 20. Further, in the above described third embodiment, “internal energy maximum data estimation means” according to the above described thirteenth to fifteenth aspects of the present invention is realized by the ECU 50 executing the processing in the above described steps 308, 310 and 316 to 324 as well as the processing described with reference to FIG. 21, “additional in-cylinder pressure calculation means” according to the above described sixteenth aspect of the present invention is realized by the ECU 50 executing the processing in the above described step 326, and “maximum heat release amount data setting means” according to the above described seventeenth and eighteenth aspect of the present inventions is realized by the ECU 50 executing the processing in the above described steps 306 and 314.

### Fourth Embodiment

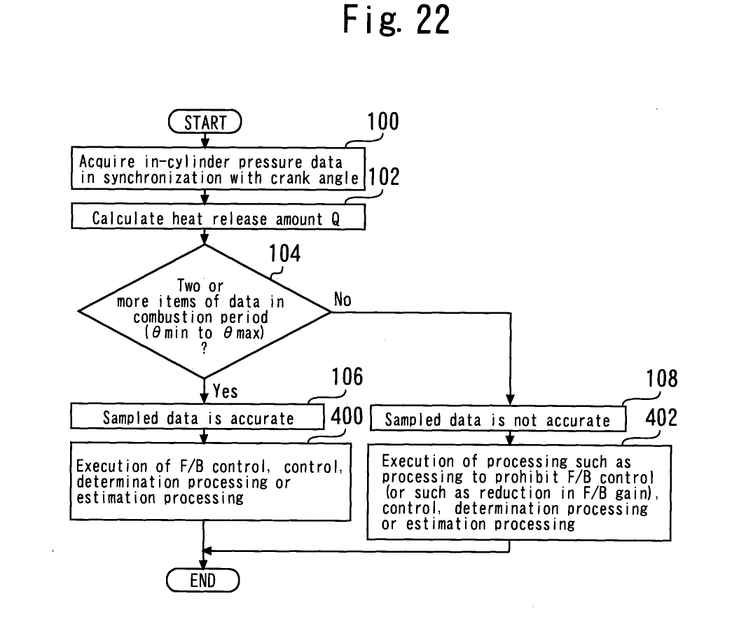

Next, a fourth embodiment of the present invention will be described referring mainly to FIG. 22.

The system of the present embodiment can be implemented by using the hardware configuration shown in FIG. 1 and causing the ECU 50 to execute a routine illustrated FIG. 22 that is described later instead of the routine illustrated in FIG. 8.

### Switching of Engine Control, Determination Processing and Estimation Processing in accordance with Result of Determining Reliability of Data

In an internal combustion engine including an in-cylinder pressure sensor such as the internal combustion engine 10 of the present embodiment, in-cylinder pressure data can be acquired that is synchronized with the crank angle using the in-cylinder pressure sensor, and various kinds of engine control, various kinds of determination processing, and processing to estimate various parameters can be performed utilizing a combustion analysis result that is based on the acquired in-cylinder pressure data. A feature of the present embodiment is that various kinds of engine control, various kinds of determination processing, and processing to estimate various parameters are switched in accordance with a result of determining the reliability of the sampling data of the in-cylinder pressure according to the first to third embodiments that are described above.

FIG. 22 is a flowchart illustrating a routine that the ECU 50 executes in the fourth embodiment of the present invention to realize switching of various kinds of engine control, various kinds of determination processing, and processing to estimate various parameters in accordance with a result of determining the reliability of sampling data of the in-cylinder pressure. In FIG. 22, steps that are the same as in FIG. 8 with respect to the first embodiment are denoted by the same reference numerals, and a description of those steps is omitted or simplified below. Although processing that switches various kinds of engine control and the like in accordance with a determination result obtained in step 104 in the routine shown in FIG. 8 will be described here, switching of various kinds of engine control and the like according to the present embodiment may also be performed in accordance with a determination result obtained in step 206 in the routine shown in FIG. 12 according to the second embodiment. Further, the description in this case relates to an example of performing processing that switches various kinds of engine control and the like together with processing that determines the reliability of in-cylinder pressure data by means of the processing in step 106 or 108. However, a configuration may also be adopted in which the processing that switches various kinds of engine control and the like of the present embodiment is executed in accordance with a determination result obtained in step 104 or 206 without being accompanied by processing that determines the reliability of in-cylinder pressure data by means of the processing in step 106 or 108.

In the routine illustrated in FIG. 22, if the ECU 50 determined in step 104 that there are two or more items of data for the heat release amount Q that were acquired during the combustion period (θmin to θmax), in step 106 the ECU 50 determines that sampling data of the in-cylinder pressure P acquired in synchronization with the crank angle is reliable (has the accuracy required for combustion analysis). The ECU 50 then advances to step 400. The following processing is executed in step 400. That is, execution of feedback (F/B) control is allowed that relates to a predetermined control target parameter using a predetermined actuator for control of the internal combustion engine 10, which is feedback control that is based on combustion analysis performed utilizing in-cylinder pressure data. As the feedback gain in this case, the respective values that was scheduled to be used for the respective kinds of feedback controls are used. Execution of control of a predetermined actuator that is based on combustion analysis performed utilizing in-cylinder pressure data is also allowed. In addition, execution of predetermined determination processing that is based on combustion analysis performed utilizing in-cylinder pressure data is allowed. Further, execution of processing to estimate predetermined parameters based on combustion analysis performed utilizing in-cylinder pressure data is allowed.

In contrast, if the ECU 50 determined in step 104 that there are not two or more items of data for the heat release amount Q that were acquired during the combustion period (θmin to θmax), in step 108 the ECU 50 determines that the sampling data of the in-cylinder pressure P acquired in synchronization with the crank angle is not reliable (does not have the required accuracy for combustion analysis). In this case, the ECU 50 advances to step 402. The following processing is executed in step 402. That is, execution of the feedback control described above with respect to step 400 is prohibited. Further, a feedback gain that is used in feedback control is reduced in comparison to the case where the processing in the above described step 400 is performed. Execution of control of an actuator described above with respect to step 400 is also prohibited. Further, execution of determination processing described above with respect to step 400 is prohibited or execution of determination processing based on another method that does not utilize in-cylinder pressure data or utilizes part of the in-cylinder pressure data is allowed. In addition, execution of estimation processing described above with respect to step 400 is prohibited or execution of estimation processing based on another method that utilizes a preset value is allowed.

Next, specific examples of various kinds of engine control, various kinds of determination processing, and processing for estimating various parameters that are switched by means of the above described processing in steps 400 and 402 in accordance with the number of items of heat release amount data acquired during a combustion period are described.

### (MBT Ignition Timing Control Using CA50)

The ignition timing can be controlled to an optimum ignition timing MBT by executing feedback control of the ignition timing so that a 50% burning point (CA50) that can be calculated by combustion analysis utilizing in-cylinder pressure data becomes a predetermined timing.

According to the above described routine illustrated in FIG. 22, execution of such MBT ignition timing control is allowed in a case where the number of items of heat release amount data during a combustion period is two or more (step 400). On the other hand, execution of the MBT ignition timing control is prohibited in a case where the number of items of heat release amount data during a combustion period is less than two (step 402). In this case, instead of prohibiting the MBT ignition timing control, a feedback gain to be used in the MBT ignition timing control may be reduced in comparison to a case where the processing in the above described step 400 is performed (step 402). Thus, a configuration may be adopted so as to perform control in which a result of combustion analysis that utilizes in-cylinder pressure data is reflected to a lesser degree than in a case where the number of items of heat release amount data acquired during a combustion period is two or more. In addition, a configuration may be adopted so as to differentiate between the respective kinds of processing that are performed when the number of items of heat release amount data is less than two so that, in a case where the number of items of heat release amount data acquired during a combustion period is one, reduction of the feedback gain is performed, while in a case where the number of items of heat release amount data acquired during a combustion period is zero, execution of the MBT ignition timing control is prohibited.

As described in the foregoing, in this example “MBT ignition timing control” corresponds to “feedback control” in the processing in the aforementioned steps 400 and 402, the “spark plug 32” corresponds to “predetermined actuator”, and “ignition timing” corresponds to “control target parameter”.

(Control to Suppress Air-to-Fuel Ratio Variations between Cylinders Using Estimated Air-to-Fuel Ratio)

A method is known for estimating an air-to-fuel ratio of a cylinder in which the in-cylinder pressure sensor 34 is disposed based on a result of combustion analysis utilizing in-cylinder pressure data. Air-to-fuel ratio variations (imbalances) between cylinders can be ascertained by acquiring the air-to-fuel ratio of the respective cylinders utilizing the in-cylinder pressure sensor 34. Thereafter, air-to-fuel ratio variations between the cylinders can be suppressed by executing feedback control of fuel injection amounts so that estimated air-to-fuel ratios of the respective cylinders become a predetermined target value (for example, the theoretical air-to-fuel ratio).

According to the routine illustrated in FIG. 22 that is described above, execution of this kind of control to suppress air-to-fuel ratio variations between cylinders is allowed in a case where the number of items of heat release amount data acquired during a combustion period is two or more (step 400). On the other hand, if the number of items of heat release amount data acquired during the combustion period is less than two, execution of control to suppress air-to-fuel ratio variations between cylinders is prohibited (step 402). In this case, instead of prohibiting the control to suppress air-to-fuel ratio variations between cylinders, a feedback gain to be used in the control to suppress air-to-fuel ratio variations between cylinders may be reduced in comparison to a case where the processing in the above described step 400 is performed (step 402). That is, in this example also, a configuration may be adopted so as to perform control in which combustion analysis that utilizes in-cylinder pressure data is reflected to a lesser degree than in a case where the number of items of heat release amount data acquired during a combustion period is two or more.

As described in the foregoing, in this example “control to suppress air-to-fuel ratio variations between cylinders” corresponds to “feedback control” in the processing in the aforementioned steps 400 and 402, the “fuel injection valve 30” corresponds to “predetermined actuator”, and “air-to-fuel ratio” corresponds to “control target parameter”.

### (AT Lock-Up Rotational Speed Control Using Torque Fluctuations Calculation Result)

In an automatic transmission (AT) that uses a torque converter, by performing a lock-up operation (direct coupling between the internal combustion engine 10 and the automatic transmission) by means of a lock-up mechanism 56, the transmission efficiency of a driving force can be increased to improve fuel efficiency. To extract this effect to a greater degree, it is desirable to set, to a low speed, an engine rotational speed (lock-up rotational speed) at which a lock-up operation is performed. However, if a lock-up operation is performed without proper consideration in a low engine rotational speed region in which torque fluctuations are liable to be large, the drivability of the vehicle deteriorates. According to combustion analysis utilizing in-cylinder pressure data, after calculating a heat release amount Q, it is possible to calculate torque (indicated torque) based on the heat release amount Q. Accordingly, torque fluctuations between cylinders can be calculated based on the calculated values of torque for the respective cylinders. In a case where torque fluctuations can be ascertained utilizing in-cylinder pressure data in this manner, it is favorable to perform control to lower the lock-up rotational speed that reduces the lock-up rotational speed while suppressing torque fluctuations to a predetermined level or less.

According to the routine illustrated in the above described FIG. 22, execution of control to lower the lock-up rotational speed is allowed in a case where the number of items of heat release amount data acquired during a combustion period is two or more (step 400). On the other hand, if the number of items of heat release amount data acquired during the combustion period is less than two, execution of control to lower the lock-up rotational speed is prohibited so that the drivability of the vehicle does not deteriorate (step 402). In this case, a configuration may also be adopted in which, instead of prohibiting the control to lower the lock-up rotational speed, execution of control that lowers the lock-up rotational speed is permitted within a possible range while allowing for an error amount due to insufficient reliability of the combustion analysis result. That is, in this example also, a configuration may be adopted so as to perform control in which combustion analysis utilizing in-cylinder pressure data is reflected to a lesser degree than in a case where the number of items of heat release amount data acquired during a combustion period is two or more.

As described in the foregoing, in this example “control to lower the lock-up rotational speed relating to the lock-up mechanism 56” corresponds to “control of an actuator” in the processing in the aforementioned steps 400 and 402.

(Control to make the Air-to-Fuel Ratio Lean Using Torque Fluctuations Calculation Result)

In a case where torque fluctuations can be ascertained utilizing in-cylinder pressure data as described above, in order to more effectively improve fuel efficiency during lean burn operation, it is favorable to perform control to make the air-to-fuel ratio lean that makes the air-to-fuel ratio leaner by decreasing a fuel injection amount using the fuel injection valve 30 while suppressing torque fluctuations to a predetermined level or less.

According to the routine illustrated in the above described FIG. 22, execution of control to make the air-to-fuel ratio lean is allowed in a case where the number of items of heat release amount data acquired during a combustion period is two or more (step 400). On the other hand, if the number of items of heat release amount data acquired during the combustion period is less than two, execution of the control to make the air-to-fuel ratio lean is prohibited so that the drivability of the vehicle does not deteriorate (step 402). In this case, a configuration may also be adopted in which, instead of prohibiting the control to make the air-to-fuel ratio lean, execution of control that makes the air-to-fuel ratio leaner is permitted within a possible range while allowing for an error amount due to insufficient reliability of the combustion analysis result. That is, in this example also, a configuration may be adopted so as to perform control in which combustion analysis utilizing in-cylinder pressure data is reflected to a lesser degree than in a case where the number of items of heat release amount data acquired during a combustion period is two or more.

As described in the foregoing, in this example “control to make the air-to-fuel ratio lean using the fuel injection valve 30” corresponds to “control of an actuator” in the processing in the aforementioned steps 400 and 402.

### (EGR Gas Amount Increase Control Using Torque Fluctuations Calculation Result)

In a case where torque fluctuations can be ascertained utilizing in-cylinder pressure data as described above, to improve fuel efficiency and improve exhaust emissions, it is favorable to perform EGR gas amount increase control that is control that increases the amount of EGR gas by adjusting the EGR valve 38 or adjusting a valve overlap period by means of the variable valve mechanisms 24 and 26 while suppressing torque fluctuations to a predetermined level or less.

According to the routine illustrated in the above described FIG. 22, execution of EGR gas amount increase control is allowed in a case where the number of items of heat release amount data acquired during a combustion period is two or more (step 400). On the other hand, if the number of items of heat release amount data acquired during the combustion period is less than two, execution of the EGR gas amount increase control is prohibited so that the drivability of the vehicle does not deteriorate (that is, the degree of opening of the EGR valve 38 is not changed, or a valve overlap period is not increased) (step 402). In this case, a configuration may also be adopted in which, instead of prohibiting the EGR gas amount increase control, execution of control that increases the EGR gas amount is permitted within a possible range while allowing for an error amount due to insufficient reliability of the combustion analysis result. That is, in this example also, a configuration may be adopted so as to perform control in which combustion analysis utilizing in-cylinder pressure data is reflected to a lesser degree than in a case where the number of items of heat release amount data acquired during a combustion period is two or more.

As described in the foregoing, in this example “EGR gas amount increase control using the EGR valve 38 or the variable valve mechanisms 24 and 26” corresponds to “control of an actuator” in the processing in the aforementioned steps 400 and 402.

### (Ignition Timing Retard Control for Warming up Catalyst Using Torque Fluctuations Calculation Result)

In a case where torque fluctuations can be ascertained utilizing in-cylinder pressure data as described above, to accelerate warming up of the catalyst 40, it is favorable to perform ignition timing retard control for raising the exhaust gas temperature while suppressing torque fluctuations to a predetermined level or less.

According to the routine illustrated in the above described FIG. 22, execution of ignition timing retard control is allowed in a case where the number of items of heat release amount data acquired during a combustion period is two or more (step 400). On the other hand, if the number of items of heat release amount data acquired during the combustion period is less than two, execution of ignition timing retard control is prohibited to avoid misfire (step 402).

As described in the foregoing, in this example “ignition timing retard control using the spark plug 32” corresponds to “control of an actuator” in the processing in the aforementioned steps 400 and 402.

(Control to Lower Rotational Speed at which an F/C is Cancelled that Uses Torque Calculation Result)

In a case where a torque can be ascertained utilizing in-cylinder pressure data as described above, to improve fuel efficiency, it is favorable to perform control to lower the rotational speed at which a fuel cut (F/C) is cancelled using the fuel injection valve 30, based on the size of torque during deceleration.

According to the routine illustrated in the above described FIG. 22, execution of such control to lower the rotational speed at which an F/C is cancelled is allowed in a case where the number of items of heat release amount data acquired during a combustion period is two or more (step 400). On the other hand, if the number of items of heat release amount data acquired during the combustion period is less than two, execution of the control to lower the rotational speed at which an F/C is cancelled is prohibited (step 402). In this case, a configuration may also be adopted in which, instead of prohibiting the control to lower the rotational speed at which an F/C is cancelled, execution of control that lowers the rotational speed at which an F/C is cancelled within a possible range while allowing for an error amount due to insufficient reliability of the combustion analysis result is permitted. That is, in this example also, a configuration may be adopted so as to perform control in which combustion analysis utilizing in-cylinder pressure data is reflected to a lesser degree than in a case where the number of items of heat release amount data acquired during a combustion period is two or more.

As described in the foregoing, in this example “control to lower the rotational speed at which an F/C is cancelled that relates to the fuel injection valve 30” corresponds to “control of an actuator” in the processing in the aforementioned steps 400 and 402.

(Torque Control when Decelerating that Uses Torque Calculation Result)

In a case where a torque can be ascertained utilizing in-cylinder pressure data as described above, it is possible to appropriately control the torque when decelerating by adjusting the fuel injection amount at the time of deceleration.

According to the routine illustrated in the above described FIG. 22, execution of such torque control when decelerating is allowed in a case where the number of items of heat release amount data acquired during a combustion period is two or more, and the fuel injection amount is appropriately controlled so that the desired torque is obtained (step 400). On the other hand, if the number of items of heat release amount data acquired during the combustion period is less than two, execution of the torque control when decelerating is prohibited to prevent the internal combustion engine 10 from stalling due to a decrease in the fuel injection amount (step 402). In this case, a configuration may also be adopted in which, instead of prohibiting the torque control when decelerating, execution of control that attempts to decrease the fuel injection amount is permitted within a possible range while allowing for an error amount due to insufficient reliability of the combustion analysis result. That is, in this example also, a configuration may be adopted so as to perform control in which combustion analysis utilizing in-cylinder pressure data is reflected to a lesser degree than in a case where the number of items of heat release amount data acquired during a combustion period is two or more.

As described in the foregoing, in this example “torque control when decelerating that uses the fuel injection valve 30” corresponds to “control of an actuator” in the processing in the aforementioned steps 400 and 402.

(Torque Control at Start-Up that Uses Torque Calculation Result)

In a case where a torque can be ascertained utilizing in-cylinder pressure data as described above, it is favorable to perform control for suppressing an excessive increase in the engine rotational speed at start-up (immediately after starting) (for example, control that suppresses torque by retarding the ignition timing).

According to the routine illustrated in the above described FIG. 22, in a case where the number of items of heat release amount data acquired during a combustion period is two or more, execution of such torque control at start-up is allowed, and retardation of the ignition timing to prevent the engine rotational speed from increasing at a rate of increase that is equal to or greater than a predetermined value at start-up is allowed (step 400). On the other hand, if the number of items of heat release amount data acquired during the combustion period is less than two, execution of the torque control at start-up is prohibited to prevent the internal combustion engine 10 from stalling due to retardation of the ignition timing (step 402).

As described in the foregoing, in this example “torque control at start-up that uses the spark plug 32” corresponds to “control of an actuator” in the processing in the aforementioned steps 400 and 402.

### (Pre-Ignition Determination Processing Using CA50 or CA10)

According to combustion analysis that utilizes in-cylinder pressure data, it is possible to calculate a 50% burning point (CA50) or a 10% burning point (CA10) using a waveform of the mass fraction burned MFB. By determining whether or not CA50 or CA10 is a value that is further on an advanced side relative to a predetermined determination value, it is possible to determine whether or not pre-ignition has occurred.

According to the routine illustrated in the above described FIG. 22, execution of such pre-ignition determination processing is allowed in a case where the number of items of heat release amount data acquired during a combustion period is two or more (step 400). On the other hand, if the number of items of heat release amount data acquired during the combustion period is less than two, execution of the pre-ignition determination processing is prohibited (step 402). In this case, a configuration may also be adopted in which, instead of prohibiting the pre-ignition determination processing, as pre-ignition determination processing based on another method that utilizes part of the in-cylinder pressure data, a determination is made that utilizes a maximum in-cylinder pressure Pmax. More specifically, a configuration may be adopted that determines that pre-ignition has occurred if the maximum in-cylinder pressure Pmax is greater than a predetermined determination value.

### (Processing to Determine Fuel Properties and Ethanol Concentration)

A method is known for determining fuel properties or a concentration of a predetermined fuel (for example, an ethanol concentration) contained in a heterogeneous mixed fuel in which different kinds of fuels are mixed, as typified by a biofuel, based on the heat release amount Q, the mass fraction burned MFB or the combustion speed that can be calculated by means of combustion analysis that utilizes in-cylinder pressure data.

According to the routine illustrated in the above described FIG. 22, execution of such processing to determine fuel properties or the like is allowed in a case where the number of items of heat release amount data acquired during a combustion period is two or more (step 400). According to the control of the internal combustion engine 10, a fuel injection amount (a largish amount) and an ignition timing (timing on the advanced side) that are based on (heavy) fuel whose properties are not favorable are used to ensure that operation of the internal combustion engine 10 can be maintained regardless of what the properties of the fuel that is used are. If it is determined by the aforementioned determination processing that the fuel properties are favorable, control is performed that decreases the fuel injection amount and retards the ignition timing. On the other hand, if the number of items of heat release amount data acquired during the combustion period is less than two, execution of the processing to determine the fuel properties or the like is prohibited (step 402). Therefore, in such case, the aforementioned fuel injection amount and ignition timing that are based on (heavy) fuel whose properties are not favorable are used.

(Processing to Determine Imbalances in Air-to-Fuel Ratio between Cylinders Using Estimated Air-to-Fuel Ratio)

As described above, imbalances (variations) in the air-to-fuel ratio between cylinders can be ascertained according to the combustion analysis that utilizes in-cylinder pressure data.

According to the routine illustrated in the above described FIG. 22, execution of such processing to determine imbalances in the air-to-fuel ratio between cylinders is allowed in a case where the number of items of heat release amount data acquired during a combustion period is two or more (step 400). On the other hand, if the number of items of heat release amount data acquired during the combustion period is less than two, execution of the processing to determine imbalances in the air-to-fuel ratio between cylinders is prohibited (step 402).

### (Misfire Determination Processing Using Heat Release Amount Q)

It is possible to determine whether or not misfiring has occurred based on whether or not a heat release amount Q that can be calculated by combustion analysis that utilizes in-cylinder pressure data is equal to or less than a predetermined determination value.

According to the routine illustrated in the above described FIG. 22, execution of such misfire determination processing is allowed in a case where the number of items of heat release amount data acquired during a combustion period is two or more (step 400). On the other hand, if the number of items of heat release amount data acquired during the combustion period is less than two, instead of the above described misfire determination processing, execution of misfire determination processing using a known rotational fluctuation method that utilizes fluctuations in the engine rotational speed as misfire determination processing based on another method that does not utilize in-cylinder pressure data is prohibited (step 402).

### (Processing to Estimate In-Cylinder Temperature and NOx Emission Amount Using Internal Energy PV)

An internal energy PV that can be calculated by combustion analysis that utilizes in-cylinder pressure data is, as described above, a parameter that is proportional to the in-cylinder temperature. Accordingly, the in-cylinder temperature can be estimated based on the internal energy PV. Further, a correlation exists between the in-cylinder temperature and an NOx emission amount. Therefore, a NOx emission amount can also be estimated based on the estimated in-cylinder temperature.

According to the routine illustrated in the above described FIG. 22, execution of such processing to estimate the in-cylinder temperature and the NOx emission amount is allowed in a case where the number of items of heat release amount data acquired during a combustion period is two or more (step 400). On the other hand, if the number of items of heat release amount data acquired during the combustion period is less than two, execution of the processing to estimate the in-cylinder temperature and the NOx emission amount is prohibited (step 402). In this case, a configuration may also be adopted in which, instead of the above described processing to estimate the in-cylinder temperature and the NOx emission amount, execution of processing to estimate the in-cylinder temperature and the NOx emission amount by another method that utilizes (holds) a preset value (for example, an estimated value at the preceding time) is allowed (step 402).

As described in the foregoing, in this example an “in-cylinder temperature” and a “NOx emission amount” correspond to “predetermined parameters” in the processing in the aforementioned steps 400 and 402.

As described in the foregoing, the term “switching of engine control” as used in the present embodiment includes various forms of switching; switching between executing and prohibiting (stopping) control (including feedback control) of an actuator; change of a feedback gain; and switching between control (including feedback control) of an actuator and control with a margin for an error in a combustion analysis result while taking into account the error. Further, the term “switching of determination processing” as used in the present embodiment includes various forms of switching: switching between executing and prohibiting determination processing that is based on a combustion analysis result with respect to in-cylinder pressure data; and switching between the determination processing that is based on the combustion analysis result and determination processing that is based on another method that does not utilize the in-cylinder pressure data or that utilizes part of the in-cylinder pressure data. In addition, the term “switching of estimation processing” as used in the present embodiment includes various forms of switching: switching between executing and prohibiting estimation processing that is based on a combustion analysis result with respect to in-cylinder pressure data; and switching between the estimation processing that is based on the combustion analysis result and estimation processing that is based on another method that utilizes a preset value.

According to the routine illustrated in the above described FIG. 22, if it is determined that the sampling data is reliable since the number of items of heat release amount data acquired during a combustion period is two or more, engine control, determination processing and estimation processing originally scheduled to be performed utilizing the in-cylinder pressure sensor 34 is executed. In contrast, if it is determined that the sampling data is not reliable because the number of items of heat release amount data acquired during a combustion period is less than two, such engine control, determination processing and estimation processing is prohibited (stopped), a feedback gain is reduced in the case of feedback control, the aforementioned determination processing based on another method that does not utilize in-cylinder pressure data or utilizes part of the in-cylinder pressure data is executed, or the aforementioned estimation processing that utilizes a preset value is executed. In other words, according to the processing of the above described routine, the degree to which a result of combustion analysis that utilizes in-cylinder pressure data is reflected in control of the next cycle is changed in accordance with the number of items of heat release amount data acquired during the combustion period (that is, according to whether the sampling data is reliable or not). More specifically, if the number of items of heat release amount data acquired during the combustion period is less than two, the aforementioned combustion analysis result is not reflected in the control of the next cycle, or the aforementioned combustion analysis result is reflected in the control of the next cycle to a lesser degree than in a case where the number of items of heat release amount data acquired during the combustion period is two or more.

As described above, according to the present routine, engine control, determination processing and estimation processing can be performed that effectively utilize a combustion analysis result with respect to in-cylinder pressure data that can be determined as reliable, and performance of engine control, determination processing and estimation processing based on combustion analysis that utilizes unreliable in-cylinder pressure data can be prevented. Further, in comparison to the conventional method which is configured to uniformly not use sampling data that is synchronized with the crank angle in a case where the engine rotational speed is lower than a predetermined value, it is possible to increase the opportunities to implement various kinds of engine control, various kinds of determination processing and various kinds of estimation processing that utilize a combustion analysis result.

Note that, in the above described fourth embodiment, “control switching means” according to the above described second aspect of the present invention, “determination processing switching means” according to the above described sixth aspect of the present invention, and “estimation processing switching means” according to the above described seventh aspect of the present invention are respectively realized by the ECU 50 executing the processing in the aforementioned step 400 or step 402 in accordance with the result determined in the aforementioned step 104.

### REFERENCE SIGNS LIST

10 internal combustion engine

12 piston

14 combustion chamber

16 intake passage

18 exhaust passage

20 intake valve

22 exhaust valve

24 intake variable valve mechanism

26 exhaust variable valve mechanism

28 throttle valve

30 fuel injection valve

32 spark plug

34 in-cylinder pressure sensor

36 EGR passage

38 EGR valve

40 catalyst

50 Electronic Control Unit (ECU)

52 crank angle sensor

54 air flow meter

56 electronically controlled lock-up mechanism

58 crankshaft

1. A control apparatus for an internal combustion engine, comprising:
an in-cylinder pressure sensor for detecting an in-cylinder pressure; and
a controller configured to:
calculate heat release amount data for inside a cylinder based on in-cylinder pressure data synchronized with a crank angle that is sampled using the in-cylinder pressure sensor; and
determine that the in-cylinder pressure data synchronized with a crank angle that is sampled is reliable in a case where a number of items of the heat release amount data located in a combustion period that is identified using the heat release amount data is two or more.

2. The control apparatus according to claim 1, further comprising an actuator for controlling the internal combustion engine,
wherein the controller switches control of the actuator based on combustion analysis that utilizes the in-cylinder pressure data between a case where the number of items of the heat release amount data located in a combustion period that is identified using the heat release amount data is two or more and a case where the number of items of the heat release amount data located in the combustion period is less than two.

3. The control apparatus according to claim 2,
wherein the controller allows execution of the control of the actuator based on combustion analysis that utilizes the in-cylinder pressure data in the case where the number of items of the heat release amount data located in the combustion period is two or more, and prohibits execution of the control of the actuator in the case where the number of items of the heat release amount data located in the combustion period is less than two.

4. The control apparatus according to claim 3,
wherein the control of the actuator is feedback control that relates to a predetermined control target parameter using the actuator and is based on combustion analysis that utilizes the in-cylinder pressure data, and
wherein the controller allows execution of the feedback control in the case where the number of items of the heat release amount data located in the combustion period is two or more, and prohibits execution of the feedback control in the case where the number of items of the heat release amount data located in the combustion period is less than two.

5. The control apparatus according to claim 3,
wherein the control of the actuator is feedback control that relates to a predetermined control target parameter using the actuator and is based on combustion analysis that utilizes the in-cylinder pressure data, and
wherein the controller reduces a feedback gain in the feedback control in the case where the number of items of the heat release amount data located in the combustion period is less than two in comparison to the case where the number of items of the heat release amount data located in the combustion period is two or more.

6. The control apparatus according to claim 1,
wherein the controller allows execution of predetermined determination processing based on combustion analysis that utilizes the in-cylinder pressure data in the case where the number of items of the heat release amount data located in the combustion period is two or more, the determination processing switching means being for prohibiting execution of the determination processing or allowing execution of the determination processing based on another method that does not utilize the in-cylinder pressure data or utilizes a part of the in-cylinder pressure data in the case where the number of items of the heat release amount data located in the combustion period is less than two.

7. The control apparatus according to claim 1,
wherein the controller allows execution of estimation processing to estimate a predetermined parameter based on combustion analysis that utilizes the in-cylinder pressure data in the case where the number of items of the heat release amount data located in the combustion period is two or more, the estimation processing switching means being for prohibiting execution of the estimation processing or permitting execution of the estimation processing utilizing a preset value in the case where the number of items of the heat release amount data located in the combustion period is less than two.

8. The control apparatus according to claim 1,
wherein the controller determines that the heat release amount data that is sampled after a combustion start timing that is a starting point of the combustion period and at or before a second crank angle at which an internal energy of in-cylinder gas exhibits a maximum value is the heat release amount data located in the combustion period.

9. The control apparatus according to claim 8,
wherein the controller determines that the in-cylinder pressure data synchronized with a crank angle that is sampled is reliable in a case where the number of items of the heat release amount data located within a period is two or more, the period starting at or after a first crank angle that is a crank angle of an item of the heat release amount data with respect to which a heat release amount first rises relative to a minimum heat release amount and ending before the second crank angle.

10. The control apparatus according to claim 8,
wherein the controller determines that, in a case where a plotted point of an internal energy maximum value in internal energy data that is calculated based on the in-cylinder pressure data and a plotted point of an item of the internal energy data that is at or after a first crank angle and is before the internal energy maximum value are collinear, the internal energy maximum value is an item of data before a true second crank angle, the first crank angle being a crank angle of an item of the heat release amount data with respect to which a heat release amount first rises relative to a minimum heat release amount.

11. The control apparatus according to claim 8,
wherein the controller determines that, in a case where a plotted point of an internal energy maximum value in internal energy data that is calculated based on the in-cylinder pressure data and a plotted point of an item of the internal energy data that is at or after a first crank angle and is before the internal energy maximum value are not collinear, an item of data that is one item before the internal energy maximum value is an item of data before a true second crank angle, the first crank angle being a crank angle of an item of the heat release amount data with respect to which a heat release amount rises relative to a minimum heat release amount.

12. The control apparatus according to claim 8,
wherein the controller determines that an item of data that is before an internal energy maximum value in internal energy data that is calculated based on the in-cylinder pressure data is an item of data that is before a true second crank angle.

13. The control apparatus according to claim 10,
wherein in a case where the plotted point of the internal energy maximum value and the plotted point of an item of the internal energy data that is at or after the first crank angle and is before the internal energy maximum value are collinear, the controller estimates that data with respect to an intersection point between a straight line that passes through the plotted point of an item of the internal energy maximum value and any two points among plotted points of items of the internal energy data that is at or after the first crank angle and is before the internal energy maximum value and a straight line that passes through plotted points of two items of data that are immediately after the internal energy maximum value is a true internal energy maximum value, and estimating that a crank angle at the intersection point is a true second crank angle.

14. The control apparatus according to claim 11,
wherein in a case where the plotted point of the internal energy maximum value and the plotted point of an item of the internal energy data that is at or after the first crank angle and is before the internal energy maximum value are not collinear, the controller estimates that data with respect to an intersection point between a straight line that passes through any two points among plotted points of items of the internal energy data that is at or after the first crank angle and is before the internal energy maximum value and a straight line that passes through the plotted point of the internal energy maximum value and a plotted point of an item of data that is one item after the internal energy maximum value is a true internal energy maximum value, and estimating that a crank angle at the intersection point is a true second crank angle.

15. The control apparatus according to claim 1,
wherein the controller estimates that data with respect to an intersection point between a straight line that passes through plotted points of two items of data that are immediately before an internal energy maximum value in internal energy data that is calculated based on the in-cylinder pressure data and a straight line that passes through plotted points of two items of data that are immediately after the internal energy maximum value is a true internal energy maximum value, and estimating that a crank angle at the intersection point is a true second crank angle.

16. The control apparatus according to claim 13,
wherein the controller calculates an in-cylinder pressure at the true second crank angle using a true internal energy maximum value and a true second crank angle that are estimated by the internal energy maximum data estimation means.

17. The control apparatus according to claim 10,
wherein in a case where the plotted point of the internal energy maximum value and the plotted point of the item of the internal energy data that is at or after the first crank angle and is before the internal energy maximum value are collinear, the controller sets, as data of a maximum heat release amount, the heat release amount data corresponding to an item of data that is one item after the internal energy maximum value or corresponding to an item of data that is a further one item after the item of data.

18. The control apparatus according to claim 11,
wherein in a case where the plotted point of the internal energy maximum value and the plotted point of item of the internal energy data that is at or after the first crank angle and is before the internal energy maximum value are not collinear, the controller sets, as data of a maximum heat release amount, the heat release amount data corresponding to the internal energy maximum value or corresponding to an item of data after the internal energy maximum value.

19. The control apparatus according to claim 14,
wherein the controller calculates an in-cylinder pressure at the true second crank angle using a true internal energy maximum value and a true second crank angle that are estimated by the internal energy maximum data estimation means.

20. The control apparatus according to claim 15,
wherein the controller calculates an in-cylinder pressure at the true second crank angle using a true internal energy maximum value and a true second crank angle that are estimated by the internal energy maximum data estimation means.
